(19) United States
(12) Patent Application Publication
(10) Pub. No.: US 2024/0299137 A1
(43) Pub. Date: Sep. 12, 2024

(54) METHODS AND APPARATUSES FOR CORRECTING OCCLUSION DURING PALATAL EXPANSION

(71) Applicant: Align Technology, Inc., San Jose, CA (US)

(72) Inventors: Jun SATO, San Jose, CA (US); Jordan HARM, Cupertino, CA (US); Jeremy RILEY, Mountain View, CA (US); Ryan KIMURA, San Jose, CA (US); Domingo CASTRO, San Jose, CA (US); Jeffrey McGUIRE, Raleigh, NC (US); Ling-Yee Angela WONG, San Jose, CA (US)

(21) Appl. No.: 18/600,581

(22) Filed: Mar. 8, 2024

Related U.S. Application Data
(60) Provisional application No. 63/489,177, filed on Mar. 8, 2023.

(51) Int. Cl. A61C 7/08; A61C 7/10

(52) U.S. Cl. CPC A61C 7/08; A61C 7/10

(57) ABSTRACT

Methods and apparatuses (devices, systems, etc.) for simultaneously applying both palatal expansion and anterior force to a subject's teeth. An orthodontic apparatus may include a palatal region extending between two or more tooth engagement regions and one or more elastic band attachments projecting laterally and/or anteriorly form the tooth engagement region(s) that securely couple an elastic band to a headgear. These methods and apparatuses may be used for nonsurgical correction of Class III malocclusions during maxillary palatal expansion treatment or during a holding period of the palatal expansion treatment, e.g., following recent palatal expansion.

### CLAIM OF PRIORITY

This patent application claims priority to U.S. Provisional Patent Application No. 63/489,177, titled “CLASS III CORRECTION DURING PALATAL EXPANSION,” filed on Mar. 8, 2023 and herein incorporated by reference in its entirety.

### BACKGROUND

Although many treatment approaches can be found in the literature regarding orthopedic and orthodontic treatment in Class III malocclusion, treatment of Class III malocclusion in growing subjects remains challenging. Class III malocclusions may result from a deficient maxilla, and one viable treatment plan may involve protracting the maxilla downward and forward. Thus, successful orthopedic correction through growth modification may provide nonsurgical correction for the growing Class III patient. In particular, maxillary expansion may be necessary in the treatment of Class III malocclusions to increase the transverse width of the maxilla. Palatal expansion may enhance orthodontic effects when treating Class III malocclusions by disrupting the maxillary suture system, which may be particularly effective in treating children.

However, existing nonsurgical techniques for palatal expansion and/or treating Class III malocclusions are unsatisfactory. What is needed are apparatuses (e.g., systems) that may be conveniently worn to progressively treat both Class III malocclusions and palatal expansion. In particular, it would be beneficial to provide methods and apparatuses for removable palatal expanders (or palatal retainers) that may be used to progressively treat Class III malocclusion

### SUMMARY OF THE DISCLOSURE

Described herein are methods and apparatuses for concurrently expanding a subject's palate (or retaining expansion of a recently expanded palate) and applying an anterior force. The anterior force may be sufficient to correct a Class III malocclusion. For example, the methods and apparatuses (devices, systems, etc.) described herein may be used for nonsurgical correction of Class III malocclusions in combination with palatal expansion and/or retention. Although the methods and apparatuses described herein may be used during maxillary palatal expansion treatment or during a holding period of the palatal expansion treatment, e.g., following recent palatal expansion to correct a Class III malocclusion, these methods and apparatuses may also be used to treat patients that do not have a Class III malocclusion, including repositioning or reorienting of teeth in an anterior direction within the dental arch and/or anteriorly shifting the maxilla (e.g., by stimulating, through applying an anterior force, separation and growth along bone suture lines such as the rear palatal suture and maxilla-zygomatic suture lines).

Any of these methods and apparatuses may include an elastic band attachment (e.g., a hook, button, slot, etc.) included as part of a patient-removable and/or insertable palatal expander and/or a palatal expander holding device for connecting one or more elastomeric material, such as an elastic rubber band, to a headgear. The combination of the palatal expander and/or palatal retainer, elastomeric material and headgear may be configured to correct Class III malocclusion while simultaneously and/or sequentially expanding a narrow maxillary arch.

For example, described herein are methods and apparatuses including one or more (in some examples, a sequence of) palatal expanders and/or palatal expansion retainers, one or more elastic bands, and a headgear Class III malocclusion. In general, these methods and apparatuses may include an elastic band attachment, such as a hook, button, etc. as part of (including in particularly, integrated into) a palatal expander apparatus, that is configured to removably couple to a headgear via an elastic material (e.g., a band or a rubber band). The elastic material may connect the palatal expander to a headgear, and in particular a Class III headgear. In some cases, this may allow simultaneous treatment of both Class III correction and palatal expansion. The treatment can continue during a holding period, following palatal expansion, by including one or more elastic band attachments on a palatal retainer.

These methods and apparatuses may be particularly advantageous as compared palatal expanders and/or palatal retainers alone. Further, the palatal expanders and/or palatal retainers configured for use with one or more with elastic band and headgear may be configured specifically to apply both anterior force (e.g., to correct Class III malocclusions) without disrupting palatal expansion, or in some cases, further assisting in palatal expansion. Surprisingly, these apparatuses may be patient-removable palatal expanders (and/or palatal retainers) that may apply significant anterior force without dislodging the palatal expander and/or retainer from the teeth, and while still allowing the user to remove palatal expander and/or retainer relatively easily.

Any of the apparatuses described herein may include one or more tooth attachment regions configured to engage with one or more tooth attachments on, e.g., bonded onto, the subject's teeth. In some examples the apparatus, including the elastic band attachment(s), may be configured to apply a force that helps the tooth attachment region to engage with the tooth attachment (e.g., driving the anterior portion of the tooth engagement region against the tooth engagement) to help retain the apparatus on the subject's teeth when the elastic is engaged with the headgear.

Any of these apparatuses may be configured to apply force to pull the upper jaw (maxillary region) anteriorly from either side of the jaw, about the subject's midline suture in a manner that enhances or preserves the palatal expansion of the suture. In any of these apparatuses the elastic band attachment and/or headgear may be configured so that the direction of force applied by the elastic (e.g., elastic band) on either side of the upper jaw is directed in parallel or anteriorly at a divergent angle. The net direction of the anterior force may be in (or may approximate) a direction of a zero moment line (ZML) that passes through the center of resistance of the patient's dentition, resulting in anterior translation of the maxilla. The elastic band attachment(s) may be positioned on a buccal side of the palatal expander so that they may couple with the headgear so that the elastic bands extending from the palatal expander engage the headgear.

Described herein are orthodontic apparatuses comprising: a left tooth engagement region configured to be removably worn over the subject's teeth in the left maxillary portion, a right tooth engagement region configured to be removably worn over the subject's teeth in the right maxillary portion, and a palatal region between the left tooth engagement region and the right tooth engagement region, a first elastic band attachment on the left tooth engagement region, and a second elastic band attachment on the right tooth engagement region. Any of these apparatuses may include a plurality of tooth attachments configured to engage with one or more attachments on the subject's teeth to secure the left and right tooth engagement regions to the subject's teeth. Any of these apparatuses may optionally include a headgear configured to be worn on the subject's head. The headgear may comprise an elastic band attachment bridge configured to couple to the first elastic band attachment by a first elastic band, and to the second clastic band attachment by a second elastic band.

The palatal region may be configured to apply force an expansion force between the left tooth engagement region and the right tooth engagement region to expand the subject's palate. The apparatus may be configured so that the first elastic band and the second elastic band extend either in parallel or form an angle that diverges anteriorly when coupled to the orthodontic appliance and the headgear. The first and second elastic band attachments may comprise one of: a hook or a button.

The first and second elastic band attachments may be positioned on an anterior buccal side of the left tooth region and the right tooth region, respectively. In some examples the first and second elastic band attachments are positioned on a posterior buccal side of the left tooth region and the right tooth region, respectively. The first and second elastic band attachments may be positioned on a buccal side of the left tooth region and the right tooth region, respectively, adjacent the buccal occlusal interface.

The right elastic band attachment and the left elastic band attachment may be configured to drive the plurality of tooth attachment regions against the tooth attachments on the subject's teeth when the first and second elastic band attachments are coupled to the elastic band attachment bridge by the first and second elastic bands.

The orthodontic appliance may be configured to removably by the subject.

For example, described herein are a series of orthodontic appliances having a sequence and configured to be sequentially worn by a subject to expand the subject's palate in the sequence and to draw the subject's maxillary region anteriorly, the series of orthodontic appliance comprising, for each orthodontic appliance in the series: a left tooth engagement region configured to be removably worn over the subject's teeth in the left maxillary portion, a right tooth engagement region configured to be removably worn over the subject's teeth in the right maxillary portion, and a palatal region between the left tooth engagement region and the right tooth engagement region, a first elastic band attachment on the left tooth engagement region, a right elastic band attachment on the right tooth engagement region, and a plurality of tooth attachment regions configured to engage with one or more attachments on the subject's teeth to secure the left and right tooth engagement regions to the subject's teeth; and a headgear configured to be worn on the subject's head, wherein the headgear comprises an elastic band attachment bridge configured to couple, for each orthodontic appliance in the series, to the first elastic band attachment by a first elastic band, and to the second elastic band attachment by a second elastic band.

Also described herein are methods of making these apparatuses. For example any of these methods and apparatuses may be designed and configured to be part of a series of patient-removably palatal expanders (in some examples, including or exclusive to one or more retainers to be worn following palatal expansion). For example, described herein are methods of making a series of palatal expanders in which one or more of the palatal expanders includes elastic band attachments configure to secure to an elastic material (e.g., band) and a headgear to which the elastic material may attach.

For example, described herein are orthodontic apparatuses comprising: a first tooth engagement region configured to be removably worn over a first subset of a subject's maxillary teeth; a second tooth engagement region configured to be removably worn over a second subset of the subject's maxillary teeth; a palatal region extending between the first tooth engagement region and the second tooth engagement region; and a first elastic band attachment projecting laterally and/or anteriorly from a region (e.g., a first region) of a buccal side of the first tooth engagement region, the elastic band attachment comprising an engagement surface configured to hold an elastic band that extends anteriorly an out of the subject's mouth.

These apparatuses may be configured so that the connection between the elastic band attachments and a headgear by the elastic band(s) result in a net direction of force that is approximately in-line with the ZML for the patient. In general, this may mean that the elastic band attachment are positioned in a more anteriorly direction (in the anterior-to-posterior axis of the apparatus) and more gingivally (in the gingival-to-occlusal axis of the buccal side of the apparatus). For example, the first elastic band attachment may project laterally from an anterior region of the buccal side of the first tooth engagement region. The region of the buccal side of the first tooth engagement region that the first elastic band attachment projects may be more gingival in a gingival-to-occlusal axis of the buccal side, so that the first elastic band attachment is configured to be positioned at least partially over the subject's gingiva when the apparatus is worn on the subject's teeth.

The first elastic band attachment may comprise a slot formed (e.g., cut, fabricated, etc.) into the region of the buccal side of the first tooth engagement region. In some examples the slot is formed in an anterior region of a removal tab that extends away from the buccal side of the apparatus in a direction that is opposite from an occlusal side of the apparatus and lateral to the buccal side. In some examples the slot comprises a channel region that opens into a holding region, wherein the diameter of the channel region is smaller than the diameter of the holding region.

The elastic band attachments may be any appropriate configuration. For example, the first elastic band attachment may comprise a button, a hook, a slot, etc.

In general, the elastic band attachment(s) may extend from a buccal side of the first tooth engagement region, when the first tooth engagement region may be configured as an incisal tooth engagement region. For example, the first tooth engagement region may be part of an incisal region of the first tooth engagement region configured to hold a subject's incisal teeth.

In any of these apparatuses, the first region of the buccal side of the first tooth engagement region may be located to be a position where a resulting moment arm is within a threshold distance from a center of resistance of the subject. The threshold distance may be, for example, about 1 mm, about 2 mm, about 3 mm, about 4 mm, about 5 mm, about 6 mm, about 7 mm, about 8 mm, about 9 mm, about 10 mm, etc.).

Any of these apparatuses may include a buccal extension that extends laterally from the first or second tooth engagement region and is configured to extend at least partially over the subject's gingiva when the apparatus is worn on the subject's teeth, wherein the first region is located on the buccal extension.

Any of these apparatuses may include a cut-out region extending adjacent to a posterior side of the first elastic band attachment so that at least a portion of the engagement surface includes a thickness of the region of the buccal side of the first tooth engagement region. In general, the term “cut-out” region refers to the space (e.g., negative space, gap, opening, void, etc.) formed in the apparatus, e.g., adjacent to the posterior side of the elastic band attachments, in this example. As used herein, a ‘cut-out’ region may be formed by any appropriate technique including direct fabrication of the region, cutting with a tool (knife, laser, etc.), ablation, etching, etc.

In general, these apparatuses may include a pair of elastic band attachments. For example, these apparatuses may include a second elastic band attachment projecting laterally and/or anteriorly from a region of a buccal side of the second tooth engagement region.

Any of these apparatuses may include a supplemental elastic band attachment projecting laterally and/or anteriorly from a region of a buccal side of the first tooth engagement region adjacent to the first elastic band attachment. The first elastic band attachment may be more gingival and more posterior than the supplemental elastic band attachment, wherein the supplemental elastic band attachment is configured so that an elastic band may engage the first elastic band attachment and the second elastic band attachment and may extend anteriorly out of the subject's mouth to apply both a counter-moment to the orthodontic apparatus.

In general, the palatal region may be configured to apply an expansion force between the first tooth engagement region and the second tooth engagement region to expand the subject's palate.

The engagement surface may comprise a plurality of contact points along a length of the engagement surface configured to re-direct force from and elastic band off axis relative to the long axis of the elastic band extending from the dental apparatus when worn. For example, the first elastic band attachment may comprise a polygonal engagement surface.

In general, the orthodontic apparatus may be configured to removably worn by the subject.

As mentioned, any of these apparatuses may include a headgear configured to be worn on the subject's head. The headgear may be configured as an elastic band attachment bridge configured to couple to the first elastic band attachment by a first elastic band.

For example, an orthodontic apparatus may include: a first tooth engagement region configured to be removably worn over a first subset of a subject's maxillary teeth; a second tooth engagement region configured to be removably worn over a second subset of a subject's maxillary teeth; a palatal region extending between the first tooth engagement region and the second tooth engagement region; a first elastic band attachment projecting laterally and/or anteriorly from a first region of a buccal side of the first tooth engagement region; a second elastic band attachment projecting laterally and/or anteriorly from a second region of a buccal side of the first tooth engagement region, the elastic band attachment comprising an engagement surface configured to hold an elastic band; and a headgear configured to be worn on the subject's head, wherein the headgear comprises an elastic band attachment bridge configured to couple to the first elastic band attachment by a first elastic band.

Any of the apparatuses and methods described herein may be configured so that the elastic band attachments are lower profile, which may increase comfort and efficacy of the elastic band attachments. For example, any of these apparatuses may include a cut-out region on the posterior region of the elastic band attachments so that the profile (e.g., width) of the engagement surface to which the elastic band may engage may include the thickness of the buccal side region. For example, described herein are orthodontic apparatuses, including: a first tooth engagement region configured to be removably worn over a first subset of a subject's maxillary teeth; a second tooth engagement region configured to be removably worn over a second subset of a subject's maxillary teeth; a palatal region extending between the first tooth engagement region and the second tooth engagement region; a first elastic band attachment projecting laterally from a region of a buccal side of the first tooth engagement region, the elastic band attachment comprising an engagement surface configured to hold an elastic band; and a cut-out region extending adjacent to a posterior side of the first elastic band attachment so that at least a portion of the engagement surface includes a thickness of the region of the buccal side of the first tooth engagement region.

The first elastic band attachment may project laterally from an anterior region of the buccal side of the first tooth engagement region, and/or a region of the buccal side of the first tooth engagement region that the first elastic band attachment projects may be more gingival in a gingival-to-occlusal axis of the buccal side, so that the first elastic band attachment is configured to be positioned at least partially over the subject's gingiva when the apparatus is worn on the subject's teeth.

The first elastic band attachment may be configured as a button.

In some examples, the region of the buccal side of the first tooth engagement region may be part of an incisal region of the first tooth engagement region configured to hold a subject's incisal teeth.

Any of these apparatuses may include a second elastic band attachment projecting laterally and/or anteriorly from a region of a buccal side of the second tooth engagement region. The palatal region may be configured to apply an expansion force between the first tooth engagement region and the second tooth engagement region to expand the subject's palate. The orthodontic apparatus may be configured to removably worn by the subject.

Also described herein are apparatuses that include a plurality of contact points for each elastic band that may redirect the force applied by the elastic band. The plurality of contact points may be on the same elastic band attachment or may be on different elastic band attachments that are adjacent to each other, or both. For example, an orthodontic apparatus may include: a first tooth engagement region configured to be removably worn over a first subset of a subject's maxillary teeth; a second tooth engagement region configured to be removably worn over a second subset of a subject's maxillary teeth; a palatal region extending between the first tooth engagement region and the second tooth engagement region; a first elastic band attachment projecting laterally from a first region of a buccal side of the first tooth engagement region; a supplemental elastic band attachment projecting laterally from a second region of the buccal side of the first tooth engagement region that is offset from the first elastic band attachment in the occlusal-gingival axis and in the anterior-posterior axis.

The supplemental elastic band attachment may be configured so that the first elastic band attachment is more gingival and more posterior than the supplemental elastic band attachment. The first elastic band attachment may project laterally from an anterior region of the buccal side of the first tooth engagement region. The region of the buccal side of the first tooth engagement region that the first elastic band attachment projects may be more gingival in a gingival-to-occlusal axis of the buccal side, so that the first elastic band attachment is configured to be positioned at least partially over the subject's gingiva when the apparatus is worn on the subject's teeth.

The first elastic band attachment may comprise a button. The region of a buccal side of the first tooth engagement region may be part of an incisal region of the first tooth engagement region configured to hold a subject's incisal teeth. As mentioned, any of these apparatuses may include a cut-out region extending adjacent to a posterior side of the first elastic band attachment so that at least a portion of the engagement surface includes a thickness of the region of the buccal side of the first tooth engagement region.

Any of these apparatuses may include a second elastic band attachment projecting laterally and/or anteriorly from a region of a buccal side of the second tooth engagement region, and a second supplemental elastic band attachment projecting laterally from a second region of the buccal side of the second tooth engagement region that is offset from the second elastic band attachment.

The palatal region may be configured to apply an expansion force between the first tooth engagement region and the second tooth engagement region to expand the subject's palate. The orthodontic apparatus may be configured to removably worn by the subject.

Also described herein are apparatuses in which the one or more (preferably a pair of) elastic band attachments are located on an incisal region of the apparatus, e.g., configured to hold the incisors. For example, an orthodontic apparatus may include: a first tooth engagement region configured to be removably worn over a first subset of a subject's maxillary teeth comprising the subject's incisal teeth; a second tooth engagement region configured to be removably worn over a second subset of the subject's maxillary teeth; a third tooth engagement region configured to be removably worn over a third subset of the subject's maxillary teeth; a palatal region extending between the first, second and third tooth engagement regions; and a first elastic band attachment projecting laterally and/or anteriorly from a region of a buccal side of the first tooth engagement region, the elastic band attachment comprising an engagement surface configured to hold an clastic band so that the elastic band may extend anteriorly.

The first elastic band attachment may project laterally from an anterior region of the buccal side of the first tooth engagement region. The region of the buccal side of the first tooth engagement region that the first elastic band attachment projects may be more gingival in a gingival-to-occlusal axis of the buccal side, so that the first elastic band attachment is configured to be positioned at least partially over the subject's gingiva when the apparatus is worn on the subject's teeth. The first elastic band attachment may comprise a button. The first elastic band attachment may comprise a hook. Any of these apparatuses may include a cut-out region extending adjacent to a posterior side of the first elastic band attachment so that at least a portion of the engagement surface includes a thickness of the region of the buccal side of the first tooth engagement region.

The apparatus may include a second elastic band attachment projecting laterally and/or anteriorly from a second region of a buccal side of the first tooth engagement region.

The palatal region may be configured to apply an expansion force between the first tooth engagement region and the second tooth engagement region to expand the subject's palate. The orthodontic apparatus may be configured to removably worn by the subject.

Also described herein are methods of using any of these apparatuses. In some examples the method may include providing any of the apparatuses described herein to a subject (e.g., patient) for treating the subject, including (but not limited to) treating a Class III malocclusion concurrently with expanding the subject's palate. The method may include providing the subject with instructions for attaching the apparatus, connecting the elastic bands, wearing the apparatus, and removing the apparatus. Optionally the subject may be instructed to apply additional apparatuses for additional stages of treatment.

For example, a method of treating a subject may include: providing an orthodontic apparatus that is configured to be worn by a subject to expand the subject's palate and to advance the subject's maxillary region anteriorly, wherein the orthodontic apparatus comprises a pair of tooth engagement regions configured to be removably worn over the subject's teeth, and a palatal region between the tooth engagement regions, wherein each tooth engagement region includes an clastic band attachment that projects laterally and/or anteriorly from a region of a buccal side of each tooth engagement region, the elastic band attachments each comprising an engagement surface configured to hold an elastic band; wherein the orthodontic apparatus is configured to be coupled to a headgear worn on the subject's head by connecting an elastic band between each elastic band attachment and an elastic band attachment bridge of the headgear so that an anterior force is applied to the subject's maxillary region from the elastic bands. Any of these methods may be methods of treating a Class III malocclusion.

The orthodontic apparatus for use in these methods may include any of the orthodontic apparatuses described herein that are configured to be coupled to the headgear and apply an anterior force from the clastic bands in a direction that approximates a zero moment line. The method may include an orthodontic appliance that is configured to apply a counterforce to the subject's teeth by coupling each elastic band to multiple contact points on the orthodontic appliance to counter a rotational moment that arises due to displacement of the clastic bands relative to a zero moment line. The orthodontic appliance may be configured to be pre-loaded with the clastic bands into the elastic band attachments, wherein the elastic band attachments are configured to secure the clastic bands within a channel when the elastic bands are in an un-tensioned configuration. Any of the methods described herein may include pre-loading an elastic band into the apparatus.

The orthodontic appliance may be configured to be worn for between 1 day and 4 weeks (e.g., between 1 day and 3 weeks, between 1 day and 2 weeks, etc.). As mentioned, the elastic band attachments may each project laterally from an anterior region of a buccal side of the tooth engagement regions. The elastic band attachments may each project from a region of the buccal side of the tooth engagement regions that is configured to be at least partially over the gingiva when the orthodontic apparatus is worn on the subject's teeth. One or both of the elastic band attachments may comprise a slot cut into the region of the buccal side of the first tooth engagement region.

The slot may be formed in an anterior region of a removal tab that extends laterally away from the buccal side in a direction that is opposite from an occlusal side of the apparatus. One or both of the elastic band attachments comprises a button. One or both of the elastic band attachments may comprise a hook. The region of a buccal side of the first tooth engagement region may be part of an incisal region of the first tooth engagement region that is configured to hold a subject's incisal teeth.

In some examples a method of treating a Class III malocclusion may include: applying an orthodontic apparatus to a subject's maxillary teeth to expand the subject's palate and to advance the subject's maxillary region anteriorly, wherein applying the orthodontic apparatus comprises attaching a first tooth engagement region over a first subset of the subject's teeth and attaching a second tooth engagement region over a second subset of the subject's teeth so that a palatal region extending between the first and second tooth engagement regions applies an expansion force therebetween; and coupling the orthodontic apparatus to a headgear worn on the subject's head by connecting an elastic band between each of one or more elastic band attachments that project from the orthodontic apparatus to an elastic band attachment bridge of the headgear so that an anterior force is applied to the subject's maxillary region from said elastic band.

For example, coupling the orthodontic apparatus to the headgear may comprise coupling a first elastic band attachment that projects laterally and/or anteriorly from a region of a buccal side of the first tooth engagement region to the elastic band attachment bridge of the headgear by said elastic band. In some examples coupling the orthodontic apparatus to the headgear comprises coupling a first and second elastic band attachment that each project laterally and/or anteriorly from a buccal side of the first tooth engagement region to the elastic band attachment bridge of the headgear by said elastic band. Coupling the orthodontic apparatus to the headgear may comprise coupling a first elastic band attachment that projects laterally and/or anteriorly from a buccal side of the first tooth engagement region to the elastic band attachment bridge of the headgear by a first elastic band and coupling a second band attachment that projects laterally and/or anteriorly from a buccal side of the second tooth engagement region to the elastic band attachment bridge of the headgear by a second elastic band. In some cases, coupling the orthodontic apparatus to the headgear comprises coupling said elastic band between the elastic band attachment bridge of the headgear and each of the one or more elastic band attachments, wherein the one or more elastic band attachments comprises a slot. Coupling the orthodontic apparatus to the headgear may comprise coupling said elastic band between the elastic band attachment bridge of the headgear and each of the one or more elastic band attachments, wherein the one or more elastic band attachments comprises a hook. In some examples, coupling the orthodontic apparatus to the headgear comprises coupling said elastic band between the elastic band attachment bridge of the headgear and each of the one or more elastic band attachments, wherein the one or more elastic band attachments comprises a button. Coupling the orthodontic apparatus to the headgear may comprise coupling a first elastic band between the elastic band attachment bridge of the headgear and one or more elastic band attachments comprising a plurality of contact points, to apply a counter rotational moment to the subject. In some examples coupling the orthodontic apparatus to the headgear comprises coupling a pre-loaded elastic band to the elastic band attachment bridge of the headgear wherein the elastic band is pre-loaded and retained in the elastic band attachment. Any of these methods may include removing, by the subject, the orthodontic apparatus and applying a second orthodontic apparatus.

Also described herein are methods of treating a Class III malocclusion, the method comprising: applying an orthodontic method to a subject's maxillary teeth to expand the subject's palate and to advance the subject's maxillary region anteriorly, wherein applying the orthodontic method comprises attaching a first tooth engagement region over a first subset of the subject's teeth and attaching a second tooth engagement region over a second subset of the subject's teeth so that a palatal region extending between the first and second tooth engagement regions applies an expansion force therebetween; and coupling the orthodontic method to a headgear worn on the subject's head by connecting an elastic band between each of one or more elastic band attachments that project from the orthodontic method to an elastic band attachment bridge of the headgear so that an anterior force is applied to the subject's maxillary region from said elastic band.

Any of these methods may include coupling the orthodontic apparatus to the headgear by coupling a first elastic band attachment that projects laterally and/or anteriorly from a region of a buccal side of the first tooth engagement region to the elastic band attachment bridge of the headgear by said elastic band. Coupling the orthodontic apparatus to the headgear may comprise coupling a first and second elastic band attachment that each project laterally and/or anteriorly from a buccal side of the first tooth engagement region to the elastic band attachment bridge of the headgear by said elastic band. In some examples coupling the orthodontic apparatus to the headgear comprises coupling a first elastic band attachment that projects laterally and/or anteriorly from a buccal side of the first tooth engagement region to the elastic band attachment bridge of the headgear by a first elastic band and coupling a second band attachment that projects laterally and/or anteriorly from a buccal side of the second tooth engagement region to the elastic band attachment bridge of the headgear by a second elastic band. For example, coupling the orthodontic apparatus to the headgear may comprise coupling said elastic band between the elastic band attachment bridge of the headgear and each of the one or more elastic band attachments, wherein the one or more elastic band attachments comprises a slot. Coupling the orthodontic apparatus to the headgear may comprise coupling said elastic band between the elastic band attachment bridge of the headgear and each of the one or more elastic band attachments, wherein the one or more elastic band attachments comprises a hook. In some examples coupling the orthodontic apparatus to the headgear comprises coupling said elastic band between the elastic band attachment bridge of the headgear and each of the one or more elastic band attachments, wherein the one or more elastic band attachments comprises a button. Coupling the orthodontic apparatus to the headgear may comprise coupling a first elastic band between the elastic band attachment bridge of the headgear and one or more elastic band attachments comprising a plurality of contact points, to apply a counter rotational moment to the subject. In some cases coupling the orthodontic apparatus to the headgear comprises coupling a pre-loaded elastic band to the elastic band attachment bridge of the headgear wherein the elastic band is pre-loaded and retained in the elastic band attachment.

Any of these methods may include removing, by the subject, the orthodontic apparatus and applying a second orthodontic apparatus.

For example, described herein are methods of treating a Class III malocclusion, the method comprising: providing series of orthodontic appliances, configured to be sequentially worn by a subject to expand the subject's palate in the sequence and to draw the subject's maxillary region anteriorly, wherein each appliance comprises a pair of tooth engagement regions configured to be removably worn over the subject's teeth, a palatal region between the tooth engagement regions, a pair of elastic band attachments, and a plurality of tooth attachments configured to engage with one or more attachments on the subject's teeth to secure the tooth engagement regions to the subject's teeth, wherein each orthodontic appliance is configured to be coupled to a headgear worn on the subject's head, wherein the headgear comprises an elastic band attachment bridge configured to couple to the elastic band attachments by two or more elastic bands. Any of these methods may include removably applying the orthodontic appliances in the sequence to expand the subject's palate while drawing the maxillary region anteriorly by applying force from two or more elastic bands (e.g., rubber bands) coupled to the elastic band attachment bridge of a headband.

In any of these methods and apparatuses, the methods described herein may include fabricating the one or more palatal expanders and/or retainers using a direct fabrication technique. Any of these methods may include providing a variety of elastic band attachment (e.g., hook, button, slot, etc.) designs at any locations. Also described herein are methods of making these apparatuses and methods of using these apparatuses. For example, any of these methods may include methods of using these apparatuses to concurrently expand a subject's palate and correct a Class III malocclusion.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 illustrates one example of a patient-removable palatal expander and a variety of different elastic band attachment features (“elastic band attachments”).

FIGS. 2A and 2B illustrate examples of patient-removably palatal expanders that may be configured as described herein to be part of a system for both palatal expansion and class III adjustment.

FIG. 3 illustrates an example of a palatal expander including tooth attachments that may aid in retention within the oral cavity as well as elastic band attachments for coupling the palatal expander to a headgear to treat a Class III malocclusion.

FIG. 4 is an example of a palatal expander having tooth attachments for retention and application of force as well as elastic band attachments for coupling the palatal expander to a headgear to treat a Class III malocclusion.

FIG. 5A shows an example of a palatal expander including tooth attachments and cut-out regions (shown here as slits into the open attachments) as well as elastic band attachments for coupling the palatal expander to a headgear to treat a Class III malocclusion.

FIG. 5B is an example of an apparatus including a palatal expander such as the one shown in FIG. 5A, as well as a pair of elastic bands and a headgear.

FIG. 5C shows another example of an apparatus including a palatal expander having elastic band attachments configured as hooks.

FIG. 6 is an example of a headgear that may be adapted for use as part of an apparatus as described herein.

FIGS. 7A and 7B illustrate examples of headgears that may be adapted for use as part of an apparatus as described herein.

FIG. 8A is an example of a headgear that may be adapted for use as part of an apparatus as described herein.

FIG. 8B schematically illustrates an example of a headgear that may be adapted for use as part of an apparatus as described herein.

FIG. 9 schematically illustrates an example the estimation of the zero moment line (ZML).

FIG. 10 is an example of a palatal expander apparatus configured to apply anterior force.

FIGS. 11A-11B illustrate an example of an elastic band attachment having a low-profile.

FIGS. 11C and 11D show side perspective views of an apparatus including the elastic band attachments shown in FIGS. 11A-11B.

FIGS. 12A-12B illustrate an example of an apparatus (e.g., palatal expander apparatus) including elastic band attachments configured as hooks to apply an anterior force when used with a headgear.

FIGS. 13A-13C show an example of an apparatus (e.g., palatal expander apparatus) including elastic band attachments configured as hooks to apply an anterior force when used with a headgear.

FIGS. 14A-14B illustrate examples of hooks that may be used with any of the apparatuses described herein.

FIGS. 15A-15B show examples of an apparatus including elastic band attachments configured as notches to apply an anterior force when used with a headgear.

FIGS. 16A-16B show examples of variations of notch-type elastic band attachments.

FIGS. 17A-17C illustrate an example of an apparatus (e.g., palatal expander apparatus) including a plurality of elastic band attachments adjacent to each other and configured to provide a rotation countermoment, as described herein.

FIGS. 18A-18B illustrate another example of an apparatus including a plurality of elastic band attachments adjacent to each other.

FIGS. 19A-19B illustrate an example of an elastic band attachment including a plurality of discrete contact points for an elastic band.

FIG. 19C shows an example of an apparatus including an elastic band attachment similar to that shown in FIGS. 19A-19B.

FIG. 20 is an example of an apparatus (e.g. palatal expander or palatal retainer apparatus) including a pair of elastic band attachments projecting anteriorly from an incisal tooth engagement region.

### DETAILED DESCRIPTION

In general, the methods and apparatuses described herein may be used to apply an anterior force to a subject that is concurrently undergoing, or has just undergone, palatal expansion. In some cases this anterior force may be used in order to correct a Class III malocclusion. Alternatively or additionally, this anterior force may be used to align one or more teeth. In general, the methods and apparatuses described herein may include a dental appliance configured as a palatal expander, or a series of such palatal expanders (e.g., a series of palatal expanders configured to be worn sequentially) and/or a palatal retainer, for use when expanding a subject's palate. These dental appliances may be configured to be releasably or removably worn by the subject over the subject's upper teeth and palatal region. These dental appliances may be advantageously removable by the subject and/or the subject's caregiver (e.g., parent, legal guardian, etc.). The dental appliances may be palatal expanders configured to engage, via one or more elastic bands, with a headgear that is configured to couple with the clastic bands anterior to the maxillary region to apply a force from the elastic bands to advance the maxillary region anteriorly while also expanding or retaining a previous expansion of the subject's palate.

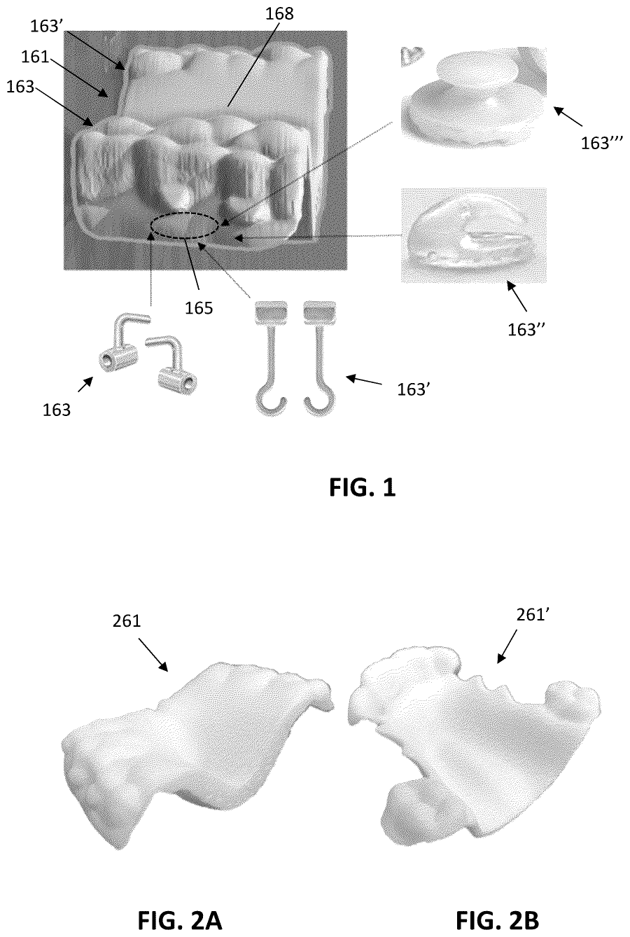

Thus, these apparatuses may be configured as palatal expanders and/or palatal retainers that are configured to retain a previous expansion, and may include one or more elastic band attachments for coupling the dental appliance (e.g., palatal expander and/or retainer) to the headgear. For example, FIG. 1 illustrates an example of an apparatus 161 including a first tooth-receiving portion 163, and a second tooth receiving portion 163′, separated by a palatal region 168. The tooth-receiving portions may include one or more elastic band attachments that may be coupled to the buccal (or in some examples, lingual) side of the apparatus at a predetermined location 165. In FIG. 1, four examples of elastic band attachments are shown, including three types of hooks 163, 163′, 163″ and also a button 163′″. An elastic band attachment may be coupled to the apparatus at a predetermined location 165, which may be selected to optimize the direction and/or magnitude of the force applied by the elastic band coupling the elastic band attachment to the headgear.

Applying an anterior force to correct Class III malocclusions while a subject's palate is undergoing palatal expansion (or during a window after the palate has been expanded and is being retained in the expanded configuration) is particularly advantageous because the palatal expansion effects facilitate skeletal changes in the anterior direction. For example, transverse forces applied during palatal expansion (e.g., to separate the mid-palatal suture) may have a synergistic effect when combined with the anterior forces contemplated herein (e.g., using headgear and elastics) in stimulating separation and growth along bone suture lines such as the rear palatal suture and maxilla-zygomatic suture lines. Thus, anterior shifting of the maxilla may be enhanced by combining palatal expansion and the Class III correction techniques disclosed herein. However, although the disclosure focuses on palatal expanders, the apparatus may alternatively be other dental appliances (a lower arch expander, an aligner, a retainer, etc.), and the Class III correction techniques and concepts may be applied mutatis mutandis to those other apparatuses without requiring palatal expansion.

FIGS. 2A and 2B illustrate alternative examples of apparatuses, configured as palatal expanders 261, 261′. These examples may include two or more elastic band attachments in any appropriate location, including on an anterior buccal region or a posterior buccal region. The elastic band attachments may be positioned near an upper region (e.g., adjacent to the buccal/occlusal region, on the buccal side) or further towards the gingival edge region of the apparatus. In some cases the elastic band attachments may be on a reinforced region of the buccal side of the palatal expander/retainer.

The apparatuses may be fabricated by any appropriate technique. For example, the apparatus may be directly printed by three-dimensional (3D) printing, and these features, e.g., elastic band attachment(s), could be integrated into the apparatus.

In general, these palatal expanders may be configured to be used with an appropriate headgear. For example, any of these palatal expanders may be connected with one or more clastic band (e.g., rubber band) to the headgear. Any appropriate elastic band may be used, for example ¼ inch, 5/16 inch, ⅜ inch, and/or ½ inch elastic bands. The elastic bands may have any appropriate pull strengths, e.g., the force the elastics exert when stretched, such as 8 oz, 14 oz, and 16 oz. For example, a ⅜ inch 8 oz, a ½ inch 14 oz, a 5/16 inch 14 oz, a 5/16 inch 16 oz, and/or a ½ inch 16 oz band may be used. Smaller elastics and lower pull strengths can be used if a smaller amount of correction is needed.

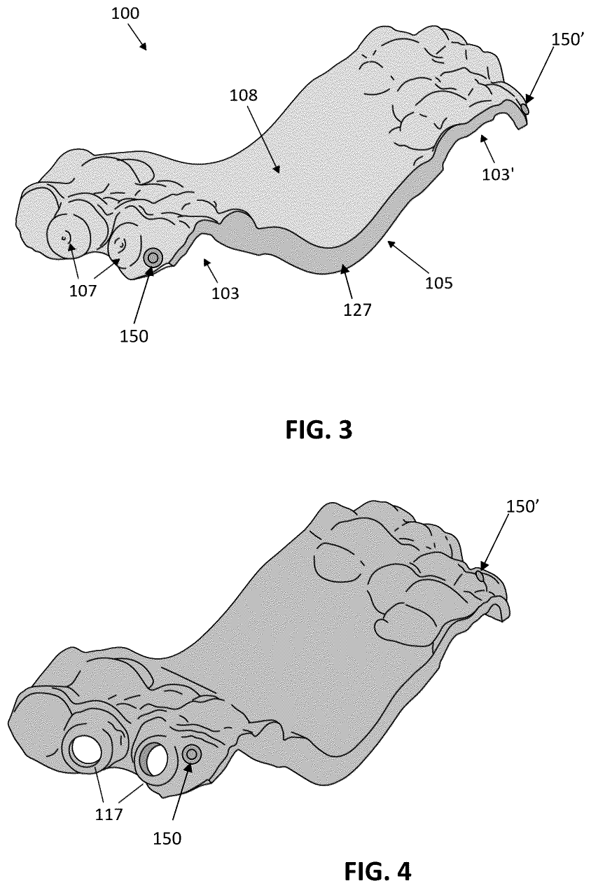

The orthodontic appliances described herein (e.g., palatal expanders) may include a tooth engagement region for engaging at least a portion of the teeth in the subject's upper jaw, in particular the molars, and a palatal region extending between the tooth engaging region that is configured to be positioned adjacent and opposite from the subject's palate when the device is worn by the subject. For example, FIG. 3 shows an example of a palatal expander 100 that includes a pair of tooth engagement regions 103, 103′ on either side of the device, connected by a palatal region 105. The palatal expander also includes a pair of elastic band attachments 150, 150′ (shown configured as “buttons”). In this example, the apparatus, which may be a palatal expander, also includes a pair of tooth attachment regions 107 that may each enclose a tooth attachment that is bonded to the subject's teeth, e.g., on either side of the device (on a buccal side of the subject's teeth; only one pair is visible). The tooth attachment may be secured (e.g., bonded) to the teeth in a position that allows it to removably couple to the tooth attachment region(s) on the apparatus. The tooth attachments may be used to aid in retention of the apparatus on the subject's teeth. A tooth attachment may be bonded (glued, etc.) to the teeth as part of an initial step prior to wearing a series of apparatuses. In the example shown in FIG. 3, the palatal region has a convex upper surface 127 that is opposite the concave lower surface 108. The lower surface is a lingual (tongue-facing) surface; the upper surface faces the palate.

The tooth engagement regions may be formed of the same material(s) as the palatal region, or they may include different materials. The thickness of the tooth engagement regions and the palatal regions may be different or the same. In particular, the palatal region may be thicker than the tooth engagement region. The thickness of the tooth engagement region may be thicker along the lateral (e.g., buccal and/or lingual) sides of the device and thinner (or removed from) across all or a portion of the top of the tooth engagement region. The palatal region may have a non-uniform thickness. For example, the palatal expander may be thicker near the midline of the device. Any of the palatal expanders may include ribs or other supports (e.g., extending transversely between the tooth engagement regions and/or perpendicular to the tooth engagement regions). These ribs may be formed of the same material as the rest of the palatal region (e.g., but be thicker and/or shaped to have a cylindrical cross-sectional profile).

The inner (cavity) portion of the tooth engagement region is typically configured to conform to the outer contour of the subject's teeth, and to rest directly against the teeth and/or a portion of the gingiva (or to avoid the gingiva) to apply force thereto. The upper surface of the palatal region which is positioned adjacent to the palate when worn by the subject may be contoured to match the actual or predicted shape of the subject's palate. As mentioned above, all or a significant portion of the palatal region may be separated or spaced from the subject's palate when worn, which may enhance comfort and minimize disruption of speech.

In some variations, a portion of the palatal region extending between the opposite tooth engagement regions on either side of the device (e.g., a portion of the palatal region extending approximately z % of the distance between the tooth engagement regions, where z is greater than about 30%, 40%, 50%, 60%, 70%, 80%, 90%, etc.) may be flat or straight, rather than curved, so that it does not necessarily follow the contour of the subject's mouth. This portion may be one or more transverse ribs, struts or supports, or it may be the flat sheet. Such a flat or straight portion may provide increase force. Alternatively or additionally, the palatal region (e.g., one or more ribs, the sheet, etc.) may be curved in an arc similar to the arc of the subject's palate, but may have a much larger radius of curvature (appearing as a shallower concavity) than the subject's palate.

As mentioned above, any of the apparatuses described herein may include one or more tooth attachment regions or sites (also referred to herein as attachment opening, attachment couplers, etc.) for coupling to a tooth attachment on the subject's teeth. In particular, it may be helpful to use one or more (e.g., a pair) of tooth attachment regions on each buccal side of the apparatus. Furthermore, the tooth attachment regions may be openings through the expander. An open structure (attachment site) on the orthodontic expander may interact with tooth attachments located on teeth to improve the overall retention of the appliance and in some cases may be used to generate advantageous force features for teeth alignment, including limiting or preventing rolling of the teeth buccally as the palate is expanded. Such features may be helpful, in particular, when included as part of a directly fabricated (e.g., 3D printed) device for rapid (e.g., phase 1) palatal expansion. Further, although the tooth attachment is typically bonded to one or more teeth and projects into a complimentary opening or cavity on the apparatus, this configuration may be reversed in some or all of these; for example, the protruding tooth attachment may be part of the expander which may insert into an opening/cavity bonded to the user's teeth.

Any appropriate tooth attachment region may be used, and in particular any appropriate size and/or shape may be used. As mentioned, the tooth attachment region may, in some examples, be an open structure 117 on the apparatus, which may improve retention of the appliance over the tooth attachments and possibly include force features for teeth alignment, as shown in FIG. 4. For example the tooth attachment region 117 may comprise a round, oval, square, rectangular, triangular, etc. opening through the expander (e.g., at a lateral, e.g., buccal, side of the tooth regaining region of the expander. The tooth attachment region may be keyed relative to the tooth attachment; in general the tooth attachment may be configured to mate with the tooth attachment region in one or a particular orientation. An open tooth attachment region may also reduce non-compliance of the appliance to poorly cured attachments.

Alternatively, the tooth attachment region may be enclosed, as shown in FIG. 3. In general, any of these tooth attachment regions may incorporate biomechanical force in the apparatus between the interaction of the tooth attachment region and the tooth attachment, including, as described above, keyed regions that transmit rotational force in the plane of the opening (e.g., against the surface of the tooth), for example. In some variations the tooth attachment may snap or couple into the tooth attachment region in a manner that requires a force to disengage the coupling.

As shown in FIG. 3, an apparatus may include a tooth attachment region that encloses the tooth attachment and helps maintain retention in the oral cavity. Alternatively, the tooth attachment regions may have an open structure, as shown in FIG. 4.

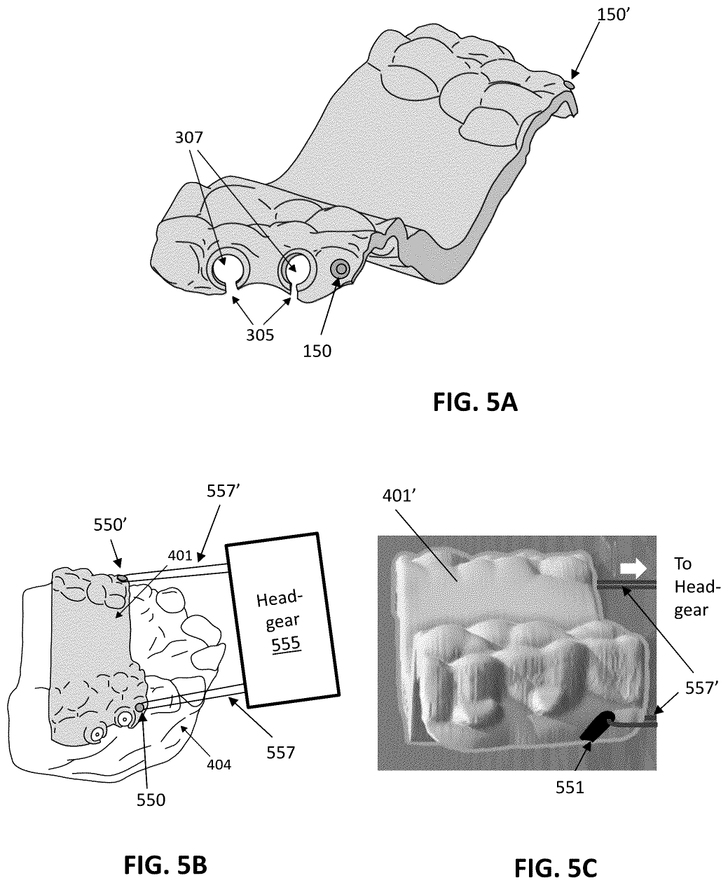

FIG. 5A illustates another example of an orthodontic apparatus as described herein, configured as a palatal epxander including a pair of elastic band attachments 150, 150′. In this example the elastic band attachments are located on an anterior region of the buccal sides of the apparatus (though in some examples, they may be located toward the back of the mouth, e.g., in posterior region). In any of the apparatuses described herein, the device may also include one more cut-out regions in which the cut-out region (e.g., slot, slit, etc.) opens to a side or edge of the apparatus. A cut-out feature such as this may increase the flexibility of the adjacent region, such as the buccal surface. When connected to or adjacent to the attachmet region opening, as shown in FIG. 5A, this configuration may increase or decrease the retention of the tooth attachment by the tooth attachment region. In FIG. 5A cut-out region (slits 305) have been added to the open structures 307 to increase the flexibility of the appliance over the tooth attachments. As will be described below, in some cases the apparatus may include a cut-out region posterior to the elastic band attachment.

FIG. 5B illustrates an example of an orthodontic appliance 401 such as the one shown in FIG. 5A coupled to a headgear 555 by a pair of elastic bands 557, 557′. A pair of elastic band attachments 550, 550′ are shown coupled to a pair of elastic bands 557 and are shown schematically coupled to a headgear 555. The apparatus is configured so that the bands are substantially parallel. In some example the bands may diverge (so that the angle of the bands relative to each other faces anteriorly). In this example the tooth attachment and coupling tooth attachment region are connected to secure the expander 401 to a (model of) subject's teeth 404.

FIG. 5C shows another example of an orthodontic apparatus 401′ coupled to a headgear (not shown) by a pair of elastic bands 557′. In this example the elastic band attachments 551 are shown as hooks, which may formed by forming a space or gap (e.g., by cutting out, direct fabrication of the gap, etc.), and optionally reinforcing, e.g., by thickening, etc., a region of the appliance.

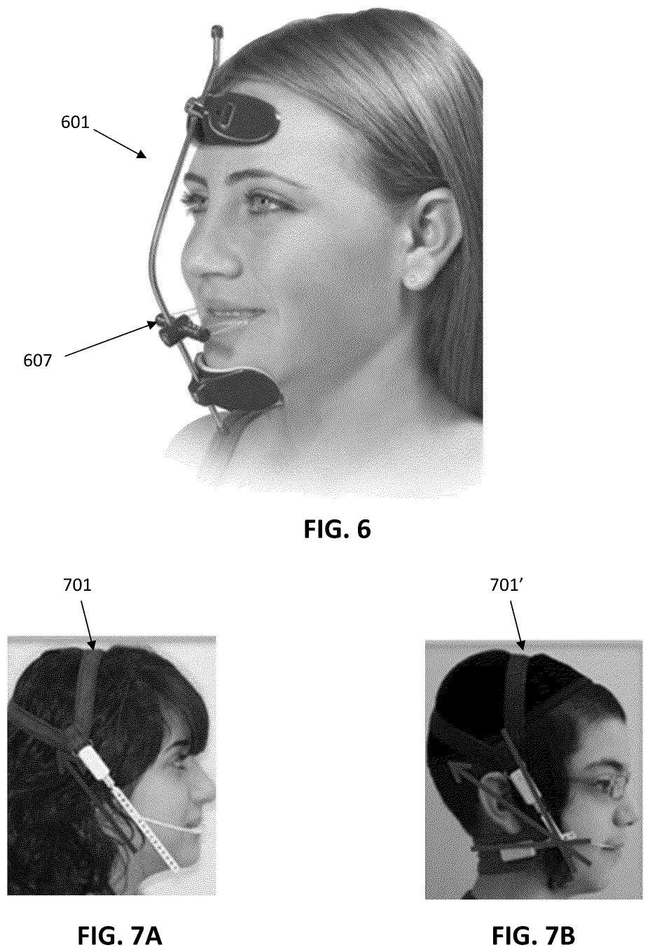

FIG. 6 shows an example of a headgear 601 that may be adapted for use including a headgear elastic band attachment bridge 607 that extends in front of the subject's mouth when worn. The elastic band attachment bridge may be configured to couple via the one or more elastic bands to the elastic band attachments on the orthodontic appliances. In order to control the angle between the clastic bands connecting the elastic band attachment bridge to the orthodontic device the elastic band attachment bridge may have length that extends away from the midsagittal plane of the head (e.g., to the left and right), to the outer corners of the mouth. The apparatus may include a unitary elastic band attachment bridge, or the elastic band attachment bridge may have two or more parts that may be connected/coupled together.

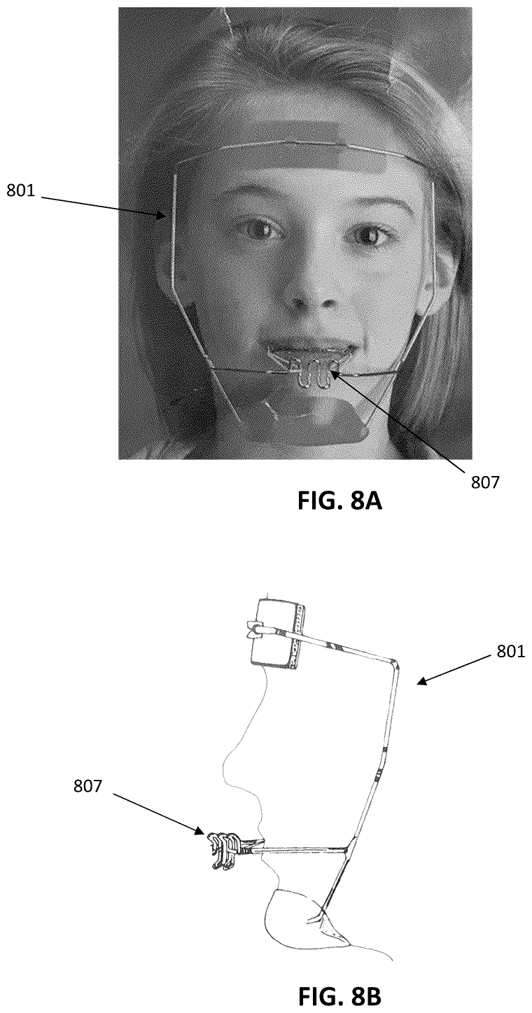

FIGS. 7A-7B and 8A-8B illustrate other examples of headgears 701, 701′ that may be adapted for use with the apparatuses described herein. For example, FIG. 8A shows an example of a headgear 801 including an elastic band attachment bridge 807 to which elastic bands may be coupled and coupled to the elastic band attachments on the patient-removable palatal expanders, as described herein. The headgear may be attached to the subject's head and may include a frame and one or more support pads. FIG. 8B schematically shows another example of the headgear of FIG. 8A, including the elastic band attachment bridge 807. The methods and apparatuses described herein may be used with any reverse pull headgear and/or other external dental appliance that uses elastics.

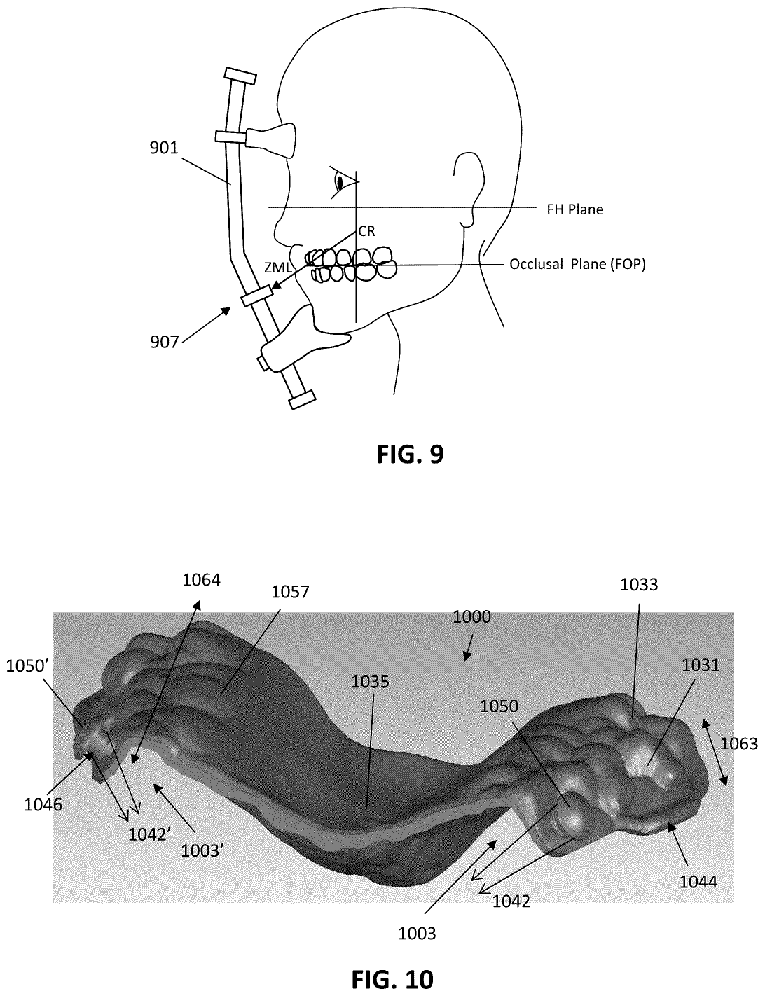

In general, the force applied by the elastic band(s) connecting the apparatus, e.g., the palatal expander apparatus, may be configured to be primarily an anterior force, in order to drive the maxilla anterior and/or to move teeth of the maxilla anteriorly within the dental arch, e.g., to correct a Class III malocclusion, while minimizing or avoiding applying a rotational moment to the maxilla (e.g., a moment that may unwantedly cause the maxilla to be rotated around an axis that is normal to the sagittal plane). This may be achieved by, for example, coordinating the position of the elastic band attachments so that the connection between the elastic band attachments and the headgear are aligned with the patient's zero moment line of force (referred to herein as “zero moment line” or “ZML”). The zero moment line is illustrated in FIG. 9. In general, the zero moment line is the line of force passing through center of resistance (CR) causing pure translation (and no rotation). Applying force along zero moment line of force may therefore result in translation of maxilla without rotation, which is desirable in most cases.

For any given subject, the ZML may be estimated based on the center of resistance (CR) of the subject's dentomaxillary complex and further based on the position of the external anchor point (e.g., an elastic band attachment bridge of a headgear). In some examples, the center of resistance of a subject's dentomaxillary complex may be clinically estimated, based on a determination of the subject's functional occlusal plane (FOP), the Frankfurt horizontal (FH) plane of the subject (or in some cases, the orbital line of the subject), and a vertical line passing distal to the root of the first permanent maxillary molar area. Although there is some adjustment that can be made to the location of the external anchor point such that the ZML can be changed, the level of adjustment is practically limited by the subject's anatomy (e.g., the location must allow for an clastic band(s) to enter the mouth of the subject through the lips). Thus, as described herein, there is significant benefit in being able to precisely control the location of the contact points at the apparatus (e.g., the elastic band attachments of a palatal expander) to better align with the ZML.

FIG. 9 schematically illustrates these landmarks, and the resulting ZML, relative to a worn headgear 901, including an elastic band attachment bridge 907. In general, the position of the elastic band attachment(s) on the palatal expander apparatus may be configured so that the resulting force applied by the elastic bands lies primarily on the ZML. Thus, in some cases it may be beneficial to position the elastic band attachments on the more anterior region of the apparatus, and in particular the more anterior region of the buccal surfaces, and/or more gingivally, e.g., towards the gingival edge region in the occlusal-gingival axis. The position of the elastic band attachments on the apparatus may be optimized by selecting a position that is close to the ZML, the goal in some cases being to reduce rotational moment. Any variation from the ZML may create a moment arm with respect to the CR, the moment arm being the perpendicular distance between the line of action of the force (at a point of contact of a respective elastic band attachment) and the CR. A larger moment arm means a larger propensity to cause rotation. So the methods disclosed herein include minimizing the moment arm, which in the standard contexts of Class III correction with a palatal expander, would position the elastic band attachments on more anterior and/or gingival regions of the palatal expander. Locating this position may involve determining (e.g., through iterative adjustment) a position at which the moment arm is below a threshold distance (e.g., about 1 mm, within about 2 mm, within about 3 mm, within about 4 mm, within about 5 mm, etc.). In general, the geometry of the palatal expander apparatus when it is worn dictates that more anterior and/or more gingival placement of the elastic band attachments positions them more closely to the ZML.

FIG. 10 illustrates an example of an apparatus 1000 (e.g., a palatal expander or retainer apparatus) including elastic band attachments 1050, 1050′. In this example, the apparatus includes a palatal region 1035 extending between a first tooth engagement region 1003 that is configured to be removably worn over a first subset of a subject's maxillary teeth and a second tooth engagement region 1003′ that is configured to be removably worn over a second subset of the subject's maxillary teeth. The first and second tooth engagement regions each include a lingual side 1057, an occlusal side 1033, and a buccal side 1031, as well as an anterior to posterior axis 1064 and an occlusal-gingival axis 1063. At least one of the tooth engagement regions includes a removal tab 1044 that extends from the buccal side (e.g., laterally outward from the buccal surface on the gingival side, that may be used to assist removal of the apparatus.

In FIG. 10, the apparatus also includes a pair of elastic band attachments 1050, 1050′ projecting laterally from the buccal side 1031 of the first 1003 and second 1003′ tooth engagement regions. Each elastic band attachment 1050 includes an engagement surface 1046 that is configured to hold an elastic band that extends anteriorly and out of the subject's mouth to apply force in an anterior direction 1042, 1042′. This force is applied to the apparatus, which then applies force to the teeth and maxilla of a subject who is wearing the apparatus.

In FIG. 10 the elastic band attachments are shown as button-shaped attachments having a post that extends laterally from the buccal surface forming the engagement surface 1046. Other attachments may be used, including hooks and notches. The positions of the clastic band attachments may be anterior and may be on the more gingival side of the buccal surface. In some cases, the apparatus may be configured so that the elastic band attachments are positioned at least partially over the gingiva when the device is worn.

In any of these apparatuses it may be particularly beneficial to reduce the amount that the clastic band attachment extends laterally from the buccal surface, referred to as the overall prominence of the elastic band attachment. The less prominent the elastic band attachment, e.g., the less the elastic band attachment sticks out of the buccal side, the less likely it will cause discomfort and interfere with the anatomy of the subject's mouth.

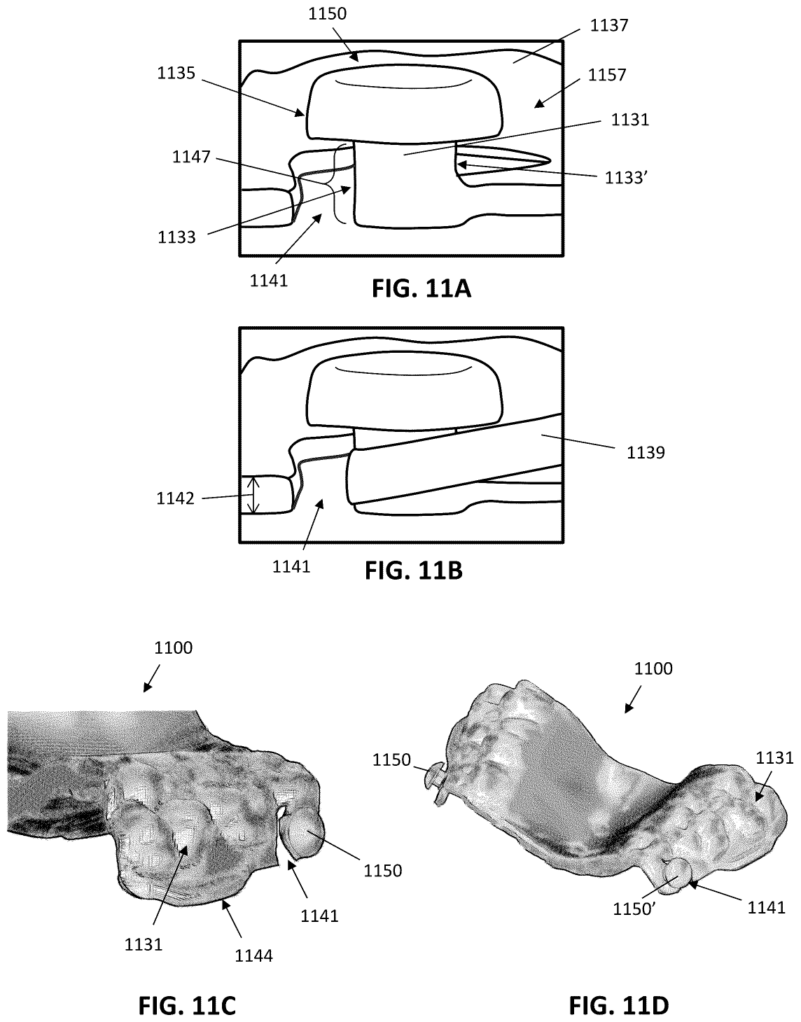

Thus, in some cases it may be particularly beneficial to reduce the prominence of the elastic band attachments, preferably without reducing the engagement surface configured to hold an elastic band. For example, FIGS. 11A-11D illustrate examples of elastic band attachments that may be configured to have a reduced prominence while maximizing the width of the engagement surface of the elastic band attachment. FIG. 11A shows an example of an elastic band attachment 1150 that is configured as a button. In this example, the elastic band attachment includes a cap region 1135 and a post 1131 having an outer surface forming an engagement surface 1133 against which an elastic band may be disposed (e.g., as shown in FIG. 11B, in which the elastic band 1139 is wrapped around the post 1133). In FIG. 11A, the elastic band attachment 1150 extends laterally from the buccal side 1157 of the palatal expander 1137.

In general, any of these apparatuses may include a buccal extension from which the elastic band attachment extends. The buccal extension may extend the elastic band attachment laterally away from the buccal side of the apparatus when the device is worn, which may help minimize contact (and therefore irritation) between the elastic band attachment and/or an attached elastic band and the gingiva. The buccal extension may also help position the elastic band attachment more in-line with the ZML.

The elastic band attachment in this example includes a cut-out region 1141 on the posterior side of the post 1131. The cut-out region extends up to the base of the post 1131, so that the effective width 1147 of the engagement surface on the posterior side 1133 is larger than the width of the engagement surface of the anterior side 1133′ of the post 1131. This is because the width of the engagement surface of the posterior side includes the thickness of buccal side 1142 in this region (as shown in FIG. 11B), which has been removed by the cut-out region 1141. On the anterior side, the width of the engagement surface 1133′ is smaller, as it only extends to the buccal surface of the dental appliance.

As shown in FIG. 11B, an elastic band 1139 typically wraps around the region of the engagement surface on the posterior side of the elastic band attachment. Furthermore, as illustrated in FIG. 11B, since the elastic contacts the elastic band attachment at an angle, Thus, the cut-out region behind the elastic band attachment increases the effective engagement region of the elastic band attachment by the width of the buccal side, without having to increase the prominence of the button.

FIGS. 11C and 11D show posterior and anterior views, respectively, of an apparatus 1100 similar to that shown in FIGS. 11A-11B. In these examples the elastic band attachments 1150, 1150′ each include a posterior cut-out region 1141 that increases the effective engagement surface for holding an clastic by the thickness of the buccal side 1131. The apparatus in this example also includes removal tabs 1144 on the buccal sides. Although FIGS. 10 and 11A-11D all show examples in which the apparatus includes elastic band attachments that are configured as buttons, in some cases the elastic band attachments may be configured as hooks, notches, and/or other engagement mechanisms that can retain an elastic band.

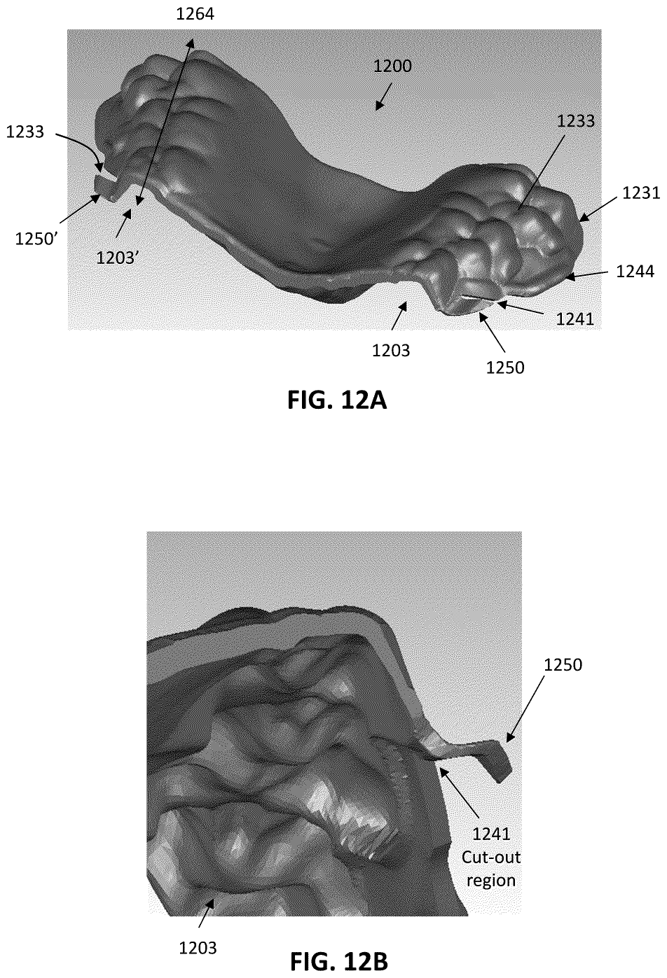

For example, FIGS. 12A-12B shows another example of an apparatus (e.g., palatal expander/retainer) similar to that shown in FIGS. 10 and 11A-11B, in which the clastic band attachments are configured as offset hooks or extensions formed by notched regions. In FIG. 12A, the apparatus (e.g., palatal expander configured to apply a transverse expansionary force and further configured to engage with one or more elastic bands and headgear to provide an anterior force) 1200 includes first 1203 and second 1203′ tooth engagement regions, that each include a buccal side 1231, an occlusal side 1233 and a lingual side. Each tooth engaging region also has an anterior-to-posterior axis 1264 and an occlusal-to-gingival axis. In FIG. 12A the elastic band attachments 1250, 1250′ on each tooth engagement region are formed as extensions (e.g., hook-shaped extensions) that include a proximal engagement surface 1233 formed by cutting out the region 1241 on the proximal side; the resulting elastic band attachments 1250 extends laterally away from the buccal side, as shown in FIG. 12B in greater detail. The apparatus also includes a removal tab 1244 and tooth attachment regions for coupling to one or more tooth attachments on the teeth.

In the elastic band attachments shown in FIGS. 12A-12B, the engagement surface is perpendicular to the buccal surface, and may be formed by the cut-out region from the buccal surface. The elastic band attachment may also include a bent-over region that extends posteriorly (e.g., forming a hook portion), which may help retain the elastic band. In some examples this region may be reinforced. In general, the region of the buccal surface forming or supporting the elastic band attachment may be reinforced, e.g., by increasing a dimension (thickness) of the region or by the use of one or more additional materials or reinforcement structures to support the region. The elastic band attachments in FIGS. 12A-12B may be sufficiently offset to allow for thicker elastics to be used, while maintaining a relatively low prominence. In some examples, the overall prominence of the hooks formed as shown in FIGS. 12A-12B may be less than that of a button having the same engagement surface width. Although in FIGS. 12A-12B the engagement surface is shown as substantially perpendicular to the plane of the buccal side, in some cases the engagement surface may be angled (e.g., between 30-90 degrees, between 40-90 degrees, between 25-90 degrees, between 50-90 degrees, between 60-90 degrees, etc.) relative to the plane of the buccal side.

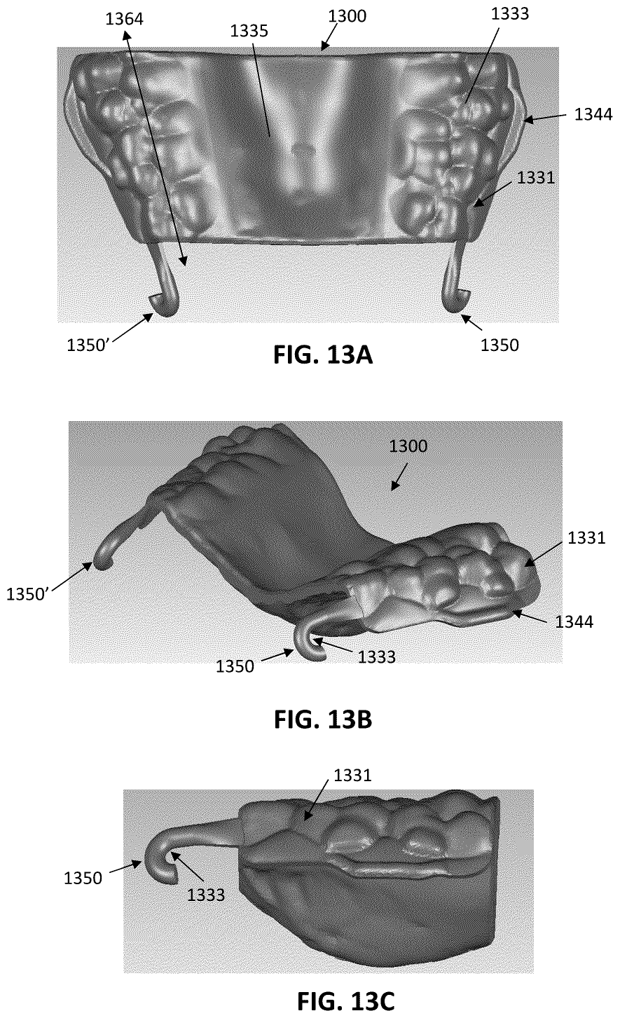

In some examples the elastic band attachment may be configured to extend anteriorly from the buccal side of the apparatus. For example, FIGS. 13A-13C illustrate an apparatus in which the elastic band attachments are configured as hooks extending anteriorly. In FIG. 13A the apparatus 1300 is configured as a palatal expander or retainer including a palatal region 1335 extending between a first tooth engagement region and a second tooth engagement region. The tooth engagement regions each have an anterior-to-posterior axis 1364. In the example shown, the apparatus also includes a pair of pull tabs 1344 to assist in removal of the device. A pair of hooks 1350, 1350′ extend anteriorly from the buccal sides of the first and tooth engagement region, as shown in FIGS. 13A-13B. The hook in this example is cane-shaped, and includes a proximal-facing engagement surface 1333 on each hook that may engage with an elastic band.

In the example apparatus shown in FIGS. 13A-13C, the point of contact (contact point) for the elastic band attachment, e.g., hook, is shown to be more anterior relative to the body of the apparatus, including the buccal side, and (in this configuration) this anterior position may allow the elastic band attachments to be more closely aligned with the ZML for the subject. In any of these apparatuses, the dimensions and relative position and orientation of the elastic band attachments (e.g., relative to the buccal side) may be adjusted and/or optimized for aligning the force from the elastic band to the ZML.

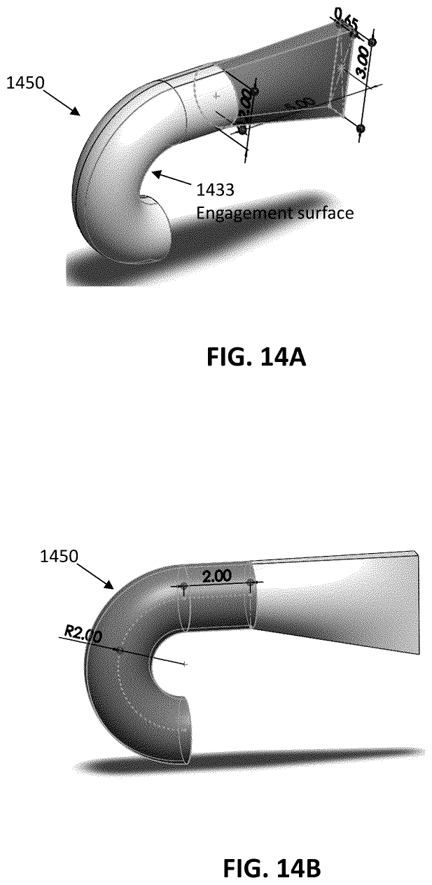

For example, FIGS. 14A-14B illustrate an example of an elastic band attachment 1450 configured as anteriorly extending hook having a posterior engagement surface 1433 for an elastic band. In this example, the dimensions shown are merely intended to be a single example and may be adjusted based on the subject anatomy and/or the headgear, including in particular the zero moment line for the subject. In any of these examples, the dimensions for the hook extension elastic band attachment can be modified based on patient-specific needs and doctor preferences (e.g., which elastics will be used, etc.). The length of the shaft of the hook, the radius of curvature of the hook, the cross-sectional diameter of the hook, etc. may all be adjusted and/or selected.

In some examples, an anterior projection that includes a cut-out region may be used in place of the cane-shaped hook of FIGS. 13A-13C and 14A-14B. For example, a buccal surface of the apparatus may be projected further anteriorly (e.g., conforming to a buccal geometry of one or more teeth that are anterior to the tooth engagement regions), and a cut-out region may be disposed along this projection (similar to the cut-out region 1241 of FIGS. 12A-12B). In other examples, instead of using a cut-out region, a button may be placed on the anterior projection. In some examples, the anterior projection may not be just a buccal surface, but may instead also cover the occlusal and lingual surfaces of one or more additional anterior teeth. Such projections may have an added advantage of being less susceptible to breakage in the manufacturing process or during use. Similar to the hook of FIGS. 13A-13C and 14A-14B, securing the elastic band to an anterior projection allows for placing the contact point more anteriorly, and thus closer to the ZML.

The elastic band attachment may be formed as a notch that is cut into the buccal side of a lateral extension from the buccal side. In some cases the elastic band attachment is formed as a notch cut into (or immediately adjacent to) the removal tab; in some cases the elastic band attachment is cut into the buccal side and/or an extension of the buccal side that is anterior to the removal tab.

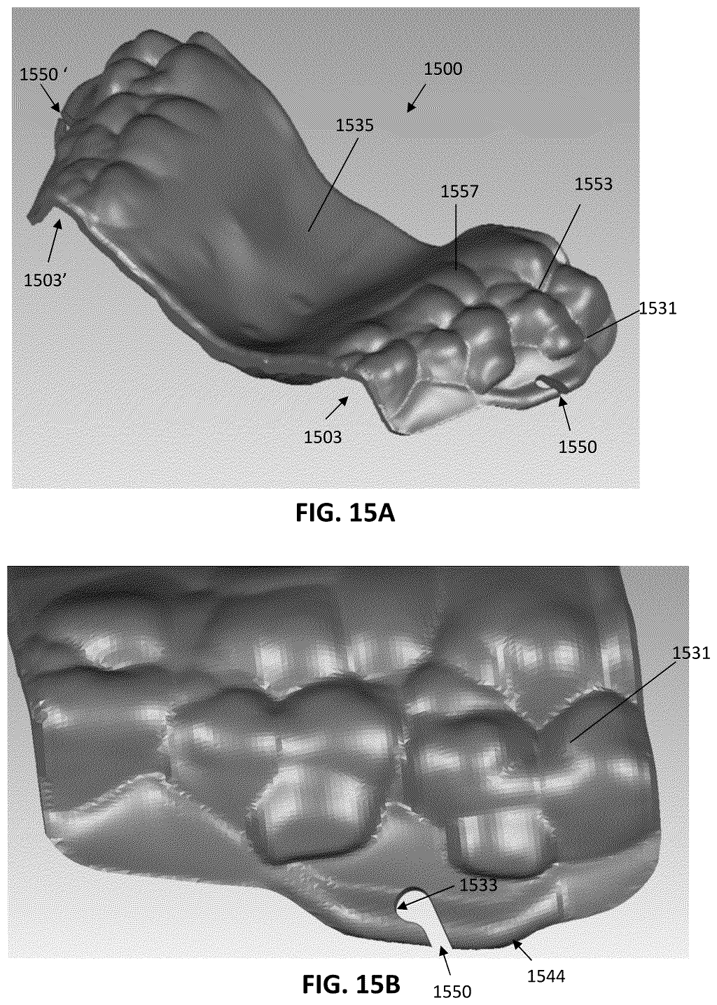

For example, FIGS. 15A-15B show an example of an apparatus 1500 configured as a palatal expander or retainer apparatus that includes a first 1503 and second 1503′ tooth engagement region with a palatal region 1535 extending between the first and second tooth engagement regions. Each tooth engagement region includes a lingual side 1557, an occlusal side 1553 and a buccal side 1531. In this example the elastic band attachment 1550, 1550′ is formed as a notch on the region extending from the gingival edge of the buccal side 1531. In this example the elastic band attachment is formed as a notched region in the laterally offset removal tab region. This may take advantage of the existing removal tab 1544 that is offset from the device when worn on the subject's teeth.

In any of these examples the notch region may be configured to hold an elastic band. In FIGS. 15A-15B the notch includes an engagement surface 1533 on the anterior side. In any of the apparatuses described herein, the elastic band attachment may be configured to securely hold the elastic band in a preloaded state. For example, the elastic band attachment may include a channel or neck region that has a smaller diameter than the outer diameter of the elastic band to be used when the elastic band is in the relaxed (unstretched) configuration, but may have a smaller diameter than the elastic band when it is stretched (e.g., reding the band diameter). The diameter of the channel may be set based on the intended type/size of the elastic band to be used.

In some examples, the apparatus may include a buccal extension that extends over the gingiva to allow for more gingival placement of elastic band attachments, and thus allow for reducing the moment arm. The buccal extensions may project laterally outward from the buccal sides of the tooth engagement regions. For example, a buccal extension on a left side may be angled outward from a buccal side of the left tooth engagement region. A clearance gap may be provided between the buccal extensions and the soft tissue of the gingiva (e.g., to prevent tissue damage, discomfort, etc.).

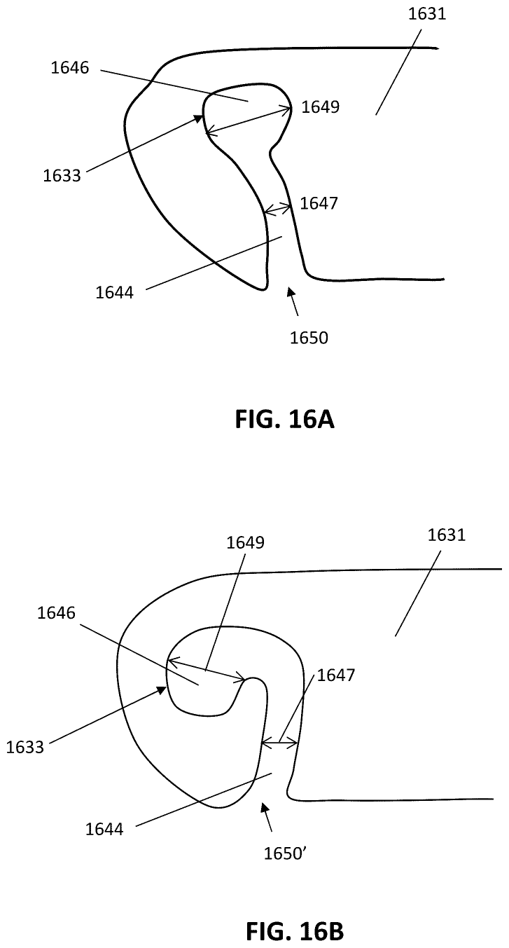

FIGS. 16A-16B illustrate an example of an elastic band attachment (in this example shown as a notch hook). FIGS. 16A-16B show an example of a region of a buccal side 1631 of an apparatus as described herein. In FIG. 16A the apparatus includes an elastic band attachment region configured as notch 1650 formed by cutting into the gingival edge of the buccal side 1631 of the apparatus. In this example the notch is configured to hold the elastic band securely prior to coupling the elastic band to the headgear, so that the elastic band may be pre-loaded into the apparatus. Alternatively, the elastic band may first be secured to both the headgear and the apparatus, and then the apparatus may be worn in the mouth, stretching the elastic band in the process. This may facilitate the securing of the elastic band as compared to a scenario where the subject has to reach within the mouth to secure the elastic band after the apparatus has been worn. In FIG. 16A the elastic band attachment is a notch having a channel region 1644 with a first gap 1647, in which the channel region opens into a holding region 1646 having a larger gap 1649 than the channel region. This elastic band attachment may therefore be pre-loaded to hold the clastic band securely within the holding region of the elastic band attachment so that it can be coupled onto the subject's upper dentition (maxilla) and the pre-loaded elastic bands may be attached to the headgear. When attached to the headgear the elastic band may be pulled against the engagement surface 1633 in the holding region 1646. FIG. 16B shows another example of an elastic band attachment configured as a slot 1650′ that also includes a narrow channel region 1644 that opens into a larger holding region 1646 including an anterior engagement surface 1633. The width of the channel region 1647 is smaller than the width of the holding region 1649 and may be configured to be smaller than the outer diameter of the elastic band. Thus, the clastic may only be able to slide out of the notch in a stretched state, which may help hold the clastic in place while the apparatus is attached to the teeth.

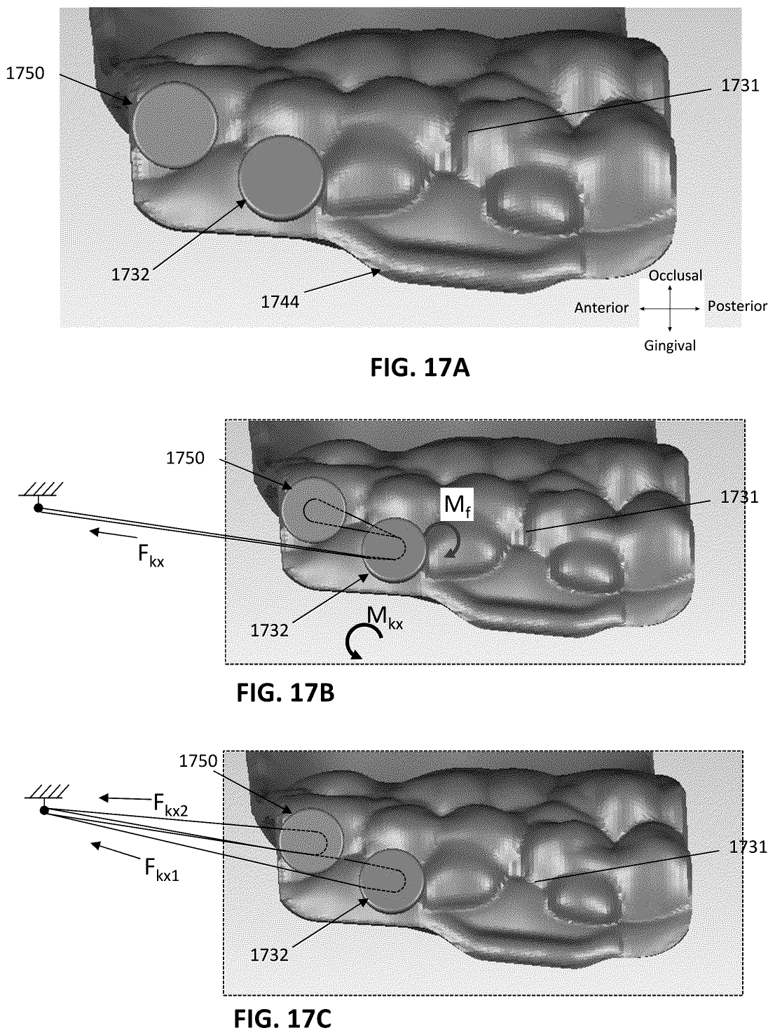

Any of these apparatuses may include two or more elastic band attachments. The use of multiple elastic band attachments may allow the direction of the force applied by the clastic bands to be adjusted. For example, in some cases the pull of the elastic band may not be in line with the zero moment line (ZML). This may result in an undesired moment about the subject's center of resistance of the maxilla (CRM) relative to the headgear anchor point (e.g., the clastic band attachment bridge of the headgear), in addition to anterior translation. This moment may cause undesired rotation or tooth movement in cases where the headgear and elastic band are intended only to provide anterior translation. To address this possibility, in some cases, the use of a second elastic band attachment (or in some cases, a second or more additional elastic band contact points) may provide a counter rotational moment that may prevent or reduce the maxilla from rotating. This is illustrated in FIGS. 17A-17C in examples in which two button-type elastic band attachments are shown.

In FIG. 17A, the buccal side 1731 of the apparatus is shown, including a first elastic band attachment 1750, and a second, e.g., supplemental, elastic band attachment 1732. In some examples the supplemental elastic band attachment may be positioned posteriorly and more gingivally (in the occlusal-gingival axis) than the first clastic band attachment. Alternatively, in some examples, the supplemental elastic band attachment may be positioned more posteriorly and more occlusally. In some cases the same elastic band may be used with both the first elastic band attachment 1750 and the supplemental elastic band attachment 1732, as shown in FIG. 17B. In this example the elastic is coupled to the headgear (e.g., at the elastic band attachment bridge of the headgear) and the force applied by the elastic band is Fₖₓ. As discussed above, coupling an clastic to an elastic band attachment may cause an undesired moment M_{f}, particularly when the clastic band is off of the ZML As illustrated in FIG. 17B, by using a system of elastic band attachments (e.g., where an elastic band first wraps around the first attachment 1750, then extends posteriorly to wrap around the supplemental elastic band attachment 1732 before extending to the headgear) the direction of force applied by the rubber band may be adjusted by the supplemental attachment(s). More complex wrapping around two or more posts may provide precise adjustments to apply a counter moment force, which may be useful to the clinician in achieving slight rotations. In general, the elastic band may be attached to the first attachment and redirected by one or more supplemental attachments to modify the direction of the force applied to the dental appliance. In FIG. 17B, redirecting the elastic band using the supplemental attachment 1732 may result in applying a counter moment Mix that may be generated about the CRM, as schematically illustrated in FIG. 17B. Thus, redirecting the clastic band in combination with the multiple contact points, including the supplemental elastic band attachment, may result in a counter moment that may prevent or reduce rotation of the maxilla (or prevent other undesired movements). In FIG. 17B, Fₖₓ is the primary force due to the stretching of the elastic band. M_{f} is the undesired moment around the elastic band attachment, and Mₖₓ is the counter moment around the maxilla's center of resistance (CRM) caused by the elastic pull from the clastic band. Any suitable number of elastic band attachments may be used, not limited to two. For example, three, four, or five elastic band attachments may be used for additional fine-tuned adjustment of moments and force directions as needed.

Alternatively, in some cases multiple elastic bands may be used for the same side of the palatal expander apparatus configured to apply an anterior force. An example of this is shown in FIG. 17C, using the same configuration of the first elastic band attachment 1750 and a supplemental elastic band attachment 1732. In this example, a different clastic is connected to each of the elastic band attachments, providing two independent force vectors on each side of the subject's dentition. This may allow for more adjustment of how much force and the direction of the force being applied (e.g., for each elastic the force applied may be Fₖₓ₁ and Fₖₓ₂. Any number of clastic band attachments may be used, not limited to two. For example, three, four, or five elastic band attachments may be used for additional fine-tuned control of the forces. In some cases asymmetric pulling may be used on the left side as compared to the right side, e.g., to advance one side more anteriorly relative to the other, e.g., by using different numbers of elastic bands on the different sides. The apparatus 1700 also includes a pull detachment tab 1744 for easy removal of the apparatus.

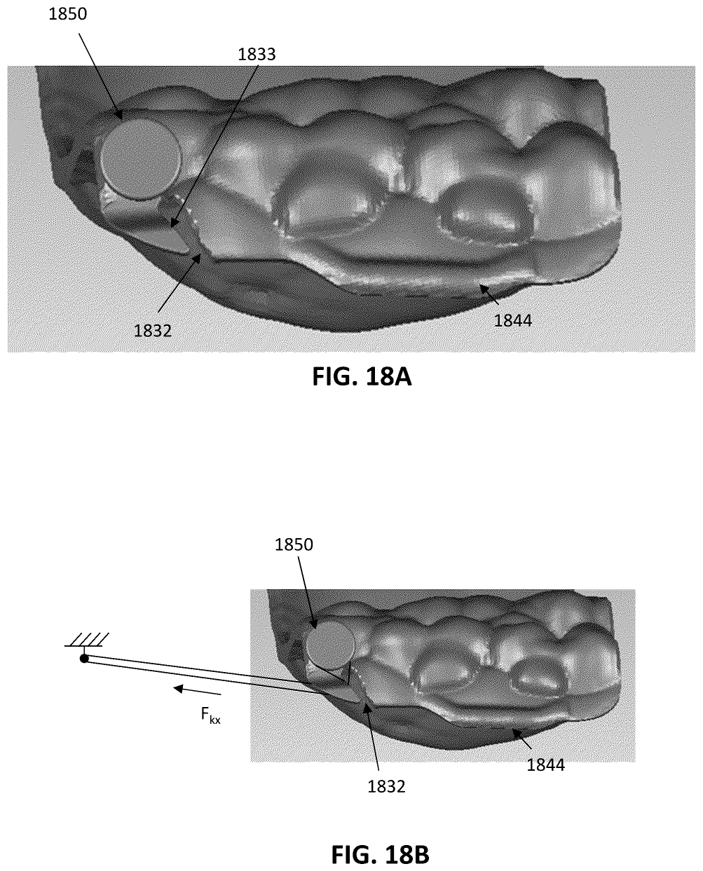

Different types of elastic band attachments may be used on the same side (in variations including two or more elastic band attachments). In FIG. 17A-17C both the elastic band attachment and the supplemental elastic band attachment are button-type attachments. FIGS. 18A-18B illustrates an example in which the first elastic band attachment is a button-type elastic band attachment 1850 and the supplemental elastic band attachment is configured as a notch/hook type elastic band attachment 1832. The supplemental elastic band attachment 1832 includes an engagement surface 1833 as described above. When an elastic band is present, it may be preloaded into the elastic band attachments. Once the apparatus is coupled, via the elastic, to the headgear (e.g., the clastic band attachment bridge of the headgear, shown schematically in FIG. 18B), the resulting force Fₖₓ, may provide sufficient anterior force to advance the maxilla anteriorly and/or may be used to apply a counter moment (not shown), e.g., similar to FIG. 17B. The apparatus also includes a pull detachment tab 1844 for easy removal of the apparatus.

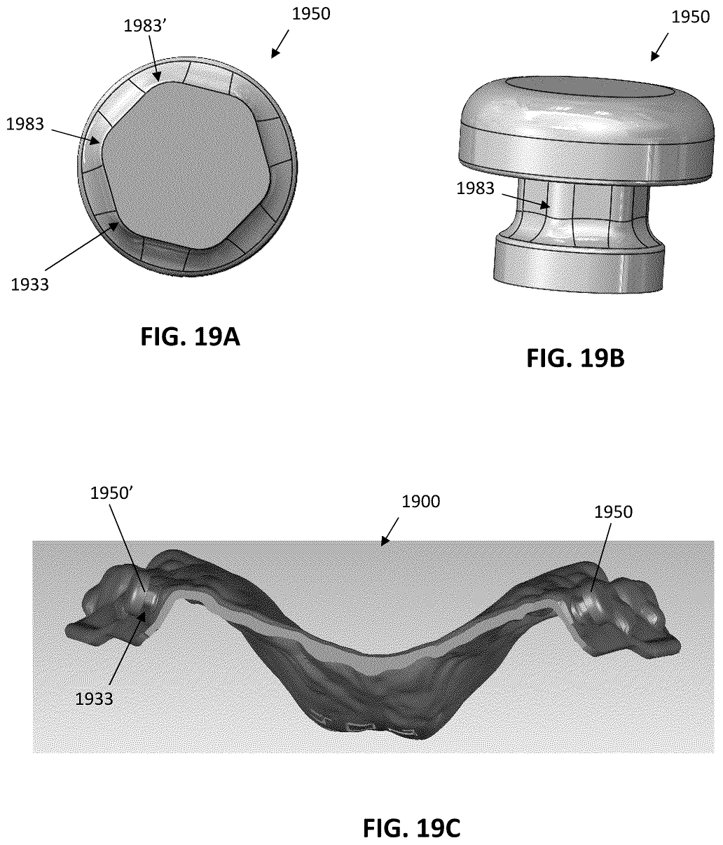

In some cases the same elastic band attachment may include multiple contact points that may modify the force(s) applied by the elastic, including directing the forces in a direction to counter rotational moments that may arise, e.g., when the force direction is off of the ZML. For example, the elastic band attachment have a shape that is configured to have multiple (e.g., two or more) sides that offer multiple discrete contact points for the elastic band when attached to the headgear. In some examples the elastic band attachment includes a post, e.g., forming the engagement surface, as described in FIGS. 11A-11B, above, and may including multiple, discrete contact points for the elastic band. In one example the elastic band attachment has a polygonal cross-section forming the engagement pathway. FIGS. 19A-19C illustrate an example of an elastic band attachment having a hexagonal cross-section including multiple contact points 1983, 1983′, etc. As shown in FIGS. 19A and 19B, the sides of the polygon could be used to create unique contact surfaces for the elastic band, creating two different force vectors (e.g., one for each side of the clastic band) that could be angled depending on the ZML. That is, the contact points can be deliberately selected by positioning and orienting such an elastic band attachment, and this thus determines the angle at which an elastic band engages the elastic band attachment. By optimizing the contact points, the engagement can be brought closer to the ZML, thus reducing undesired forces and moments, and enhancing anterior translation as discussed previously. FIG. 19A shows a top view of the elastic band attachment 1950 having an engagement surface 1933 with multiple discrete contact points 1983 formed as a polygonal, e.g., hexagonal, cross-section to the elastic band attachment. FIG. 19B shows the elastic band attachment of FIG. 19A in a side perspective view. FIG. 19C shows an example of an apparatus (e.g., palatal expander or retainer apparatus) 1900 with a pair of elastic band attachments 1950, 1950′ configured as in FIGS. 19A-19B. The post of the attachment, forming the engagement surface for contacting the elastic band, can be any suitable shape that allows for controlling the contact points with an elastic band (e.g., triangular, rectangular, octagonal). In some examples, the post need not be polygonal, and may instead have curved surfaces (e.g., curved surfaces with one or more peaks and valleys) that still allow for discrete contact points.

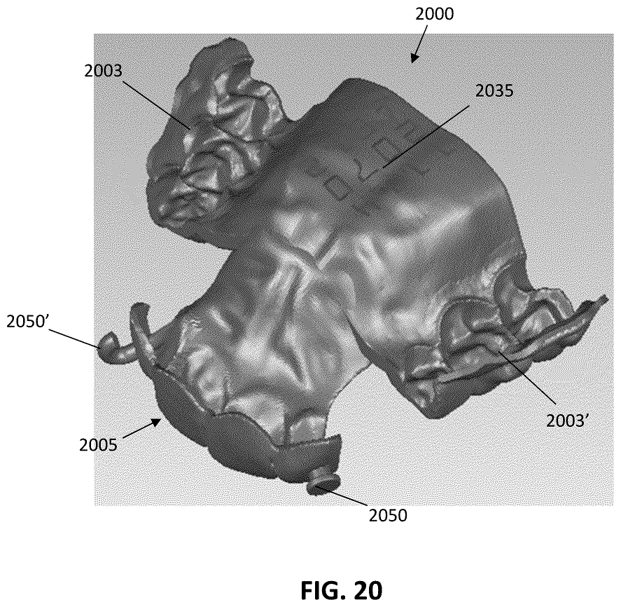

In any of these apparatuses one or more of the tooth engagement region may be configured to receive the incisor and the elastic band attachment may be coupled to this incisal tooth engagement region, similar to that shown in FIGS. 2B and 20. For example, in FIG. 2B the apparatus (e.g., palatal expander 261′) includes a first tooth engagement region 2005 that is configured to be removably worn over a first subset of a subject's maxillary teeth comprising the subject's incisal teeth, a second tooth engagement region 2003 configured to be removably worn over a second subset of the subject's maxillary teeth, and a third tooth engagement region configured to be removably worn over a third subset of the subject's maxillary teeth 2003′. The apparatus also includes a palatal region 2035 extending between the first, second and third tooth engagement regions. Two anterior elastic band attachments are shown both extending from opposite ends of the first tooth engagement region. In FIG. 20, the first elastic band attachment 2050 is configured as a button which projects laterally and anteriorly from a region of a buccal side of the first tooth engagement region. This first elastic band attachment 2050 includes an engagement surface configured to hold an elastic band so that the clastic band may extend anteriorly. In FIG. 20, the second elastic band attachment 2050′ is configured as a hook, similar to that shown in FIGS. 13A-13C and 14A-14B. The configuration shown in FIG. 20 may assist the elastic bands to pull along the zero moment line by positioning the elastic band attachments at the most anterior section of the device. Either the central or lateral incisors can be used. Any type of clastic band attachment may be used.

As discussed above, the apparatus may be other dental appliances (a lower arch expander, an aligner, a retainer, etc.), and the Class III correction techniques and concepts may be applied mutatis mutandis. For example, for correcting Class II malocclusions (e.g., overbite), the mandible (i.e., the lower jaw) and/or mandibular teeth may be advanced using headgear and elastics. In this example, clastic band attachments may be positioned on an appliance (e.g., a lower arch expander, an aligner) that is worn over teeth of the mandible. The elastic band attachments may be positioned as described above by considering the ZML (e.g., minimizing the distance between the ZML and the elastic band attachments by positioning the elastic band attachments more gingivally or anteriorly. Moreover, a supplemental elastic band attachment may be used to create a suitable counter moment.

In any of the apparatuses described herein, different clastic bands, e.g., clastic bands having different sizes and/or properties (clasticities) may be used. In use, any of these apparatuses may be provided for attachment to the patient's teeth to allow concurrent and/or sequential palatal expansion and class III correction.

Any of the apparatuses described herein may be configured to apply force from the elastic band attachments to advance the maxilla anteriorly. In some examples this force may be balanced, so that the net force applied by the one or more elastic band attachments acting on the headgear and the dental appliance is pull anteriorly. For example, elastic bands applied between one or more attachments on each side of a dental appliance and a headgear may be balanced. However, in some cases it may be desirable and/or beneficial to apply inequal forces between one or more clastic band attachments on one side of the dental appliance and the headgear as compared to the force(s) applied between one or more elastic band attachments on the other side of the dental appliance and the headgear. For example, asymmetrical pulling could be used if a patient needs their left side advanced more than their right side (or vice versa). This may be achieved by altering the position and/or orientation of the elastic band attachment(s) on the left side as compared to the right side of the dental appliance, and/or by adjusting the attachment site of the clastic on the headgear, e.g., the elastic band attachment bridge. For example, locating an elastic band attachment on the left side more posteriorly than an elastic band attachment on the right side changes the force vector such that the maxilla may be caused to pulled more toward the left side. Alternatively or additionally, asymmetrical pulling may be achieved by adjusting the type, size or number of elastic bands connecting the elastic band attachments engaging the elastic band attachments on the left side as compared with the right side of the dental appliance.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An orthodontic apparatus, the apparatus comprising:
a first tooth engagement region configured to be removably worn over a first subset of a subject's maxillary teeth;
a second tooth engagement region configured to be removably worn over a second subset of the subject's maxillary teeth;
a palatal region extending between the first tooth engagement region and the second tooth engagement region; and
a first elastic band attachment projecting laterally and/or anteriorly from a first region of a buccal side of the first tooth engagement region, the elastic band attachment comprising an engagement surface configured to hold an elastic band that extends anteriorly and out of the subject's mouth.

2. The apparatus of claim 1, wherein the first elastic band attachment projects laterally from an anterior region of the buccal side of the first tooth engagement region.

3. The apparatus of claim 1, wherein the first region is located to be a position where a resulting moment arm is within a threshold distance from a center of resistance of the subject.

4. The apparatus of claim 1, further comprising a buccal extension that extends laterally from the first or second tooth engagement region and is configured to extend at least partially over the subject's gingiva when the apparatus is worn on the subject's teeth, wherein the first region is located on the buccal extension.

5. The apparatus of claim 1, wherein the first elastic band attachment comprises a slot cut into the region of the buccal side of the first tooth engagement region.

6. The apparatus of claim 5, wherein the slot is formed in an anterior region of a removal tab that extends away from the buccal side of the apparatus in a direction that is opposite from an occlusal side of the apparatus and lateral to the buccal side.

7. The apparatus of claim 5, wherein the slot comprises a channel region that opens into a holding region, wherein the diameter of the channel region is smaller than the diameter of the holding region.

8. The apparatus of claim 1, wherein the first elastic band attachment comprises a button, a notch, or a hook.

9. The apparatus of claim 1, wherein the region of a buccal side of the first tooth engagement region is part of an incisal region of the first tooth engagement region configured to hold a subject's incisal teeth.

10. The apparatus of claim 1, further comprising a cut-out region extending adjacent to a posterior side of the first elastic band attachment so that at least a portion of the engagement surface includes a thickness of the region of the buccal side of the first tooth engagement region.

11. The apparatus of claim 1, further comprising a second elastic band attachment projecting laterally and/or anteriorly from a region of a buccal side of the second tooth engagement region.

12. The apparatus of claim 1, further comprising a supplemental elastic band attachment projecting laterally and/or anteriorly from a region of a buccal side of the first tooth engagement region adjacent to the first elastic band attachment.

13. The apparatus of claim 12, wherein the first elastic band attachment is more gingival and more posterior than the supplemental elastic band attachment, wherein the supplemental elastic band attachment is configured so that an elastic band may engage the first elastic band attachment and the second elastic band attachment and may extend anteriorly out of the subject's mouth to apply both a counter-moment to the orthodontic apparatus.

14. The apparatus of claim 1, further comprising a headgear configured to be worn on the subject's head, wherein the headgear comprises an elastic band attachment bridge configured to couple to the first elastic band attachment by a first elastic band.

15. The apparatus of claim 1, wherein the palatal region is configured to apply an expansion force between the first tooth engagement region and the second tooth engagement region to expand the subject's palate.

16. The apparatus of claim 1, wherein the engagement surface comprises a plurality of contact points along a length of the engagement surface configured to re-direct force from and elastic band off axis relative to the long axis of the elastic band extending from the dental apparatus when worn.

17. The apparatus of claim 1, wherein the first elastic band attachment comprises a polygonal engagement surface.

18. The apparatus of claim 1, wherein the orthodontic apparatus is configured to be removably worn by the subject.

19. An orthodontic apparatus, the apparatus comprising:
a first tooth engagement region configured to be removably worn over a first subset of a subject's maxillary teeth;
a second tooth engagement region configured to be removably worn over a second subset of a subject's maxillary teeth;
a palatal region extending between the first tooth engagement region and the second tooth engagement region;
a first elastic band attachment projecting laterally and/or anteriorly from a first region of a buccal side of the first tooth engagement region;
a second elastic band attachment projecting laterally and/or anteriorly from a second region of a buccal side of the first tooth engagement region, the elastic band attachment comprising an engagement surface configured to hold an elastic band; and
Class III malocclusion headgear configured to be worn on the subject's head, wherein the headgear comprises an elastic band attachment bridge configured to couple to the first elastic band attachment by a first elastic band.

20. An orthodontic apparatus, the apparatus comprising:
a first tooth engagement region configured to be removably worn over a first subset of a subject's maxillary teeth;
a second tooth engagement region configured to be removably worn over a second subset of a subject's maxillary teeth;
a palatal region extending between the first tooth engagement region and the second tooth engagement region;
a first elastic band attachment projecting laterally from a region of a buccal side of the first tooth engagement region, the elastic band attachment comprising an engagement surface configured to hold an elastic band; and
a cut-out region extending adjacent to a posterior side of the first elastic band attachment so that at least a portion of the engagement surface includes a thickness of the region of the buccal side of the first tooth engagement region.

21.-74. (canceled)
